(19) United States
(12) Patent Application Publication
(10) Pub. No.: US 2025/0093065 A1
(43) Pub. Date: Mar. 20, 2025

(54) LEARNING DEVICE, AIR CONDITIONING CONTROL SYSTEM, INFERENCE DEVICE, AIR CONDITIONING CONTROL DEVICE, AND TRAINED MODEL GENERATION METHOD

(71) Applicant: Mitsubishi Electric Corporation, Chiyoda-ku, Tokyo (JP)

(72) Inventor: Hajime IKEDA, Chiyoda-ku, Tokyo (JP)

(73) Assignee: Mitsubishi Electric Corporation, Chiyoda-ku, Tokyo (JP)

(21) Appl. No.: 18/724,374

(22) PCT Filed: Dec. 22, 2022
(86) PCT No.: PCT/JP2022/047484

§ 371 Date: Jun. 26, 2024

(30) Foreign Application Priority Data
Jan. 5, 2022 (JP) 2022-000590

(51) Int. Cl. F24F 11/64

(52) U.S. Cl. CPC F24F 11/64

(57) ABSTRACT

A simulator of a learning device simulates a thermal environment of an indoor space predicted to result from air conditioning of the indoor space by an air conditioner in a situation in which at least one of a state of a refrigeration cycle included in the air conditioner and a state of the indoor space is given. A reinforcement learner executes reinforcement learning that employs, as a reward, a value based on the thermal environment simulated by the simulator, and thereby generates a trained model aimed at inferring, from the at least one of the state of the refrigeration cycle and the state of the indoor space, a control value of the air conditioner.

### TECHNICAL FIELD

The present disclosure relates to a learning device, an air conditioning control system, an inference device, an air conditioning control device, a method of generating a trained model, a trained model, and a program.

### BACKGROUND ART

Some techniques have been known to control an air conditioner in accordance with an environment of an indoor space. For example, Patent Literature 1 discloses an information processing device that executes reinforcement learning to learn control procedures for a refrigeration cycle. The reinforcement learning involves determining whether a variation in the environment caused by an action of an agent is desirable for the agent on the basis of a reward value given to the agent, and learning a policy of actions providing higher reward values.

The information processing device disclosed in Patent Literature 1 executes reinforcement learning, using data sets containing combinations of states during the operation of an air conditioner, comfort levels of a user, and electric power consumptions of the air conditioner. In this reinforcement learning, a higher reward value is given for a higher comfort level and a lower electric power consumption. The reinforcement learning can thus provide the optimum control values of the refrigeration cycle for ensuring both of a sufficiently high comfort level and energy-saving performance.

### CITATION LIST

### Patent Literature

Patent Literature 1: Japanese Patent No. 6885497

### SUMMARY OF INVENTION

### Technical Problem

The reinforcement learning in the technique disclosed in Patent Literature 1 implements values measured in the real environment actually including the air conditioner. This reinforcement learning thus requires a long period until convergence, and cannot contribute to appropriate control of the air conditioner before convergence of the reinforcement learning.

An objective of the present disclosure, which has been accomplished in view of the above problems, is to reduce the period of reinforcement learning in the control of an air conditioner based on the reinforcement learning.

### Solution to Problem

In order to achieve the above objective, a learning device according to the present disclosure includes simulation means for simulating a thermal environment of an indoor space that is predicted to result from air conditioning of the indoor space by an air conditioner in a situation in which at least one of a state of a refrigeration cycle included in the air conditioner or a state of the indoor space is given, and reinforcement learning means for executing reinforcement learning that employs, as a reward, a value based on the thermal environment simulated by the simulation means, and thereby generating a trained model aimed at inferring, from the at least one of the state of the refrigeration cycle or the state of the indoor space, a control value of the air conditioner.

### Advantageous Effects of Invention

The learning device according to the present disclosure simulates a thermal environment of the indoor space predicted to result from air conditioning of the indoor space by the air conditioner in a situation in which at least one of the state of the refrigeration cycle included in the air conditioner or the state of the indoor space is given. The learning device also executes reinforcement learning that employs, as a reward, a value based on the simulated thermal environment, and thereby generates a trained model aimed at inferring, from the at least one of the state of the refrigeration cycle and the state of the indoor space, a control value of the air conditioner. The learning device according to the present disclosure can therefore reduce the period required for reinforcement learning involved in the control of the air conditioner using the reinforcement learning.

### BRIEF DESCRIPTION OF DRAWINGS

FIG. 1 illustrates an entire configuration of an air conditioning control system according to Embodiment 1;

FIG. 2 illustrates a configuration of a refrigeration cycle according to Embodiment 1;

FIG. 3 is a cross-sectional view of an indoor unit according to Embodiment 1;

FIG. 4 illustrates a state in which the indoor unit illustrated in FIG. 3 delivers air in a downward direction;

FIG. 5 illustrates an indoor space in the case of the state illustrated in FIG. 4;

FIG. 6 illustrates a state in which the indoor unit illustrated in FIG. 3 delivers air in a horizontal direction;

FIG. 7 illustrates the indoor space in the case of the state illustrated in FIG. 6;

FIG. 8 illustrates a situation in which the indoor unit delivers air to the indoor space subject to introduction of the ambient air in Embodiment 1;

FIG. 9 is a block diagram illustrating a configuration of a learning device according to Embodiment 1;

FIG. 10 illustrates exemplary input and output of data into and from individual components of the learning device according to Embodiment 1;

FIG. 11 illustrates inspection volumes used for simulation of the refrigeration cycle in Embodiment 1;

FIG. 12 is a flowchart illustrating a MAC method for simulating a temperature distribution in Embodiment 1;

FIG. 13 illustrates an exemplary mesh defined for simulating a temperature distribution in Embodiment 1;

FIG. 14 illustrates an exemplary piece of training data in Embodiment 1;

FIG. 15 illustrates an exemplary Q-table in Embodiment 1;

FIG. 16 illustrates an exemplary neural network in Embodiment 1;

FIG. 17 is an explanatory diagram for defining a state of the refrigeration cycle in Embodiment 1;

FIG. 18 illustrates a Q-table used for refrigeration cycle control in Embodiment 1;

FIG. 19 illustrates a neural network used for the refrigeration cycle control in Embodiment 1;

FIG. 20 illustrates sites for temperature measurement and a direction of delivered air for defining a state of the indoor space in Embodiment 1;

FIG. 21 illustrates a Q-table used for airflow control in Embodiment 1;

FIG. 22 illustrates a neural network used for the airflow control in Embodiment 1;

FIG. 23 is a flowchart illustrating a reinforcement learning process executed by the learning device according to Embodiment 1;

FIG. 24 is a block diagram illustrating a configuration of an air conditioning control device according to Embodiment 1;

FIG. 25 illustrates exemplary input and output of data into and from individual components of the air conditioning control device according to Embodiment 1;

FIG. 26 illustrates an exemplary procedure of measuring a temperature distribution in the indoor space in Embodiment 1;

FIG. 27 is a block diagram illustrating a configuration of a learning device according to Embodiment 2;

FIG. 28 illustrates exemplary pieces of preferred environment data acquired from multiple users in Embodiment 2;

FIG. 29 illustrates a probabilistic model generated from the pieces of preferred environment data illustrated in FIG. 28 in Embodiment 2;

FIG. 30 illustrates exemplary pieces of training data generated from the probabilistic model illustrated in FIG. 29 in Embodiment 2;

FIG. 31 is a block diagram illustrating a configuration of a learning device according to Embodiment 3;

FIG. 32 is a flowchart illustrating a model correcting process executed by the learning device according to Embodiment 3; and

FIG. 33 is a block diagram illustrating a configuration of an inference device according to a modification.

### DESCRIPTION OF EMBODIMENTS

The following describes some embodiments of the present disclosure with reference to the accompanying drawings. In the drawings, the components identical or corresponding to each other are provided with the same reference symbol.

### Embodiment 1

FIG. 1 illustrates an entire configuration of an air conditioning system 11 according to Embodiment 1. The air conditioning system 11 conditions the air in an indoor space on the basis of results of reinforcement learning. The air conditioning system 11 includes an air conditioner 10 and an air conditioning control system 12. The air conditioning control system 12 includes a learning device 30 and an air conditioning control device 50.

### Air Conditioner 10

The air conditioner 10 is a facility for conditioning the air in the indoor space, which is an air-conditioning target. Examples of the air conditioner 10 include room air conditioner and package air conditioner. The indoor space is a room of a house or office, for example. The air conditioner 10 includes an indoor unit 1 installed in the indoor space, and an outdoor unit 2 installed outside the indoor space.

### Refrigeration Cycle Control

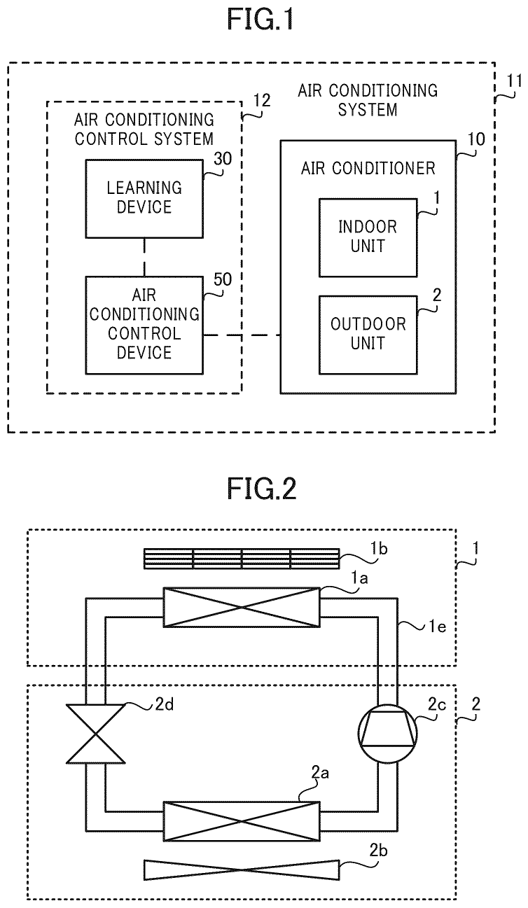

As illustrated in FIG. 2, the indoor unit 1 includes indoor heat exchangers 1a and an indoor fan 1b therein. The outdoor unit 2 includes an outdoor heat exchanger 2a, an outdoor fan 2b, a compressor 2c, and an expansion valve 2d therein. The indoor heat exchangers 1a, the compressor 2c, the outdoor heat exchanger 2a, and the expansion valve 2d are connected in an annular shape with refrigerant piping 1e in which refrigerant flows. These connected components constitute a refrigeration cycle. Examples of the refrigerant include carbon dioxide and hydrofluorocarbon (HFC).

The indoor heat exchangers 1a facilitate heat exchange between the refrigerant flowing in the refrigerant piping 1e and the indoor air, which is the air in the indoor space. The indoor fan 1b is disposed adjacent to the indoor heat exchangers 1a. The indoor fan 1b draws the indoor air and sends the air to the indoor heat exchangers 1a. The indoor air drawn by the indoor fan 1b is sent to the indoor heat exchangers 1a, subject to heat exchange with the low-temperature or high-temperature refrigerant flowing in the refrigerant piping 1e, and then delivered to the indoor space. The air after the heat exchange at the indoor heat exchangers 1a is delivered to the indoor space as conditioned air. This process conditions the air in the indoor space.

The outdoor heat exchanger 2a facilitates heat exchange between the refrigerant flowing in the refrigerant piping 1e and the outdoor air, which is the air outside the indoor space. The outdoor fan 2b is disposed adjacent to the outdoor heat exchanger 2a. The outdoor fan 2b draws the outdoor air and sends the air to the outdoor heat exchanger 2a. The outdoor air drawn by the outdoor fan 2b is sent to the outdoor heat exchanger 2a, subject to heat exchange with the low-temperature or high-temperature refrigerant flowing in the refrigerant piping 1e, and then delivered to the outside.

The compressor 2c compresses the refrigerant and causes the refrigerant to circulate in the refrigerant piping 1e. Specifically, the compressor 2c compresses the low-temperature and low-pressure refrigerant and outputs the high-temperature and high-pressure refrigerant. The compressor 2c includes an inverter circuit that can vary the operation volume in accordance with the frequency for driving the compressor 2c. The operation volume indicates a volume of refrigerant to be output from the compressor 2c per unit time.

The expansion valve 2d is disposed between the outdoor heat exchanger 2a and the indoor heat exchangers 1a. The expansion valve 2d reduces the pressure of the refrigerant flowing in the refrigerant piping 1e and expands the refrigerant. A typical example of the expansion valve 2d is an electronic expansion valve having a variable aperture. Varying the aperture of the expansion valve 2d can adjust the pressure of the refrigerant flowing in the refrigerant piping 1e.

The temperature of the refrigerant flowing in the refrigerant piping 1e is adjusted by the rotational speed of the indoor fan 1b, the rotational speed of the outdoor fan 2b, the frequency of the compressor 2c, and the aperture of the expansion valve 2d. The adjustment of the temperature of the refrigerant flowing in the refrigerant piping 1e controls the temperatures of the indoor heat exchangers 1a and the outdoor heat exchanger 2a. Such control of the temperatures of the indoor heat exchangers 1a and the outdoor heat exchanger 2a by adjusting at least any of the rotational speed of the indoor fan 1b, the rotational speed of the outdoor fan 2b, the frequency of the compressor 2c, and the aperture of the expansion valve 2d is called “refrigeration cycle control”.

The refrigeration cycle includes a four-way valve, which is not illustrated, for changing the direction of flow of the refrigerant. The four-way valve can be switched to determine whether each of the indoor heat exchangers 1a and the outdoor heat exchanger 2a serves as an evaporator or a condenser. The four-way valve can thus switch the operation between the heating operation and the cooling operation. Specifically, in the cooling operation, the indoor heat exchangers 1a serve as evaporators, whereas the outdoor heat exchanger 2a serves as a condenser. In the heating operation, the indoor heat exchangers 1a serve as condensers, whereas the outdoor heat exchanger 2a serves as an evaporator.

### Airflow Control

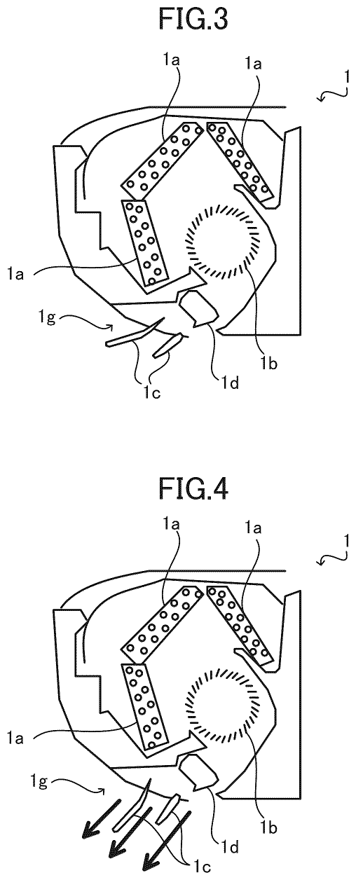

FIG. 3 illustrates a cross section of the indoor unit 1. FIG. 3 illustrates an example in which the indoor unit 1 is a wall-mounted room air conditioner. The indoor unit 1 includes, in addition to the indoor heat exchangers 1a and the indoor fan 1b, two types of airflow direction controlling plates 1c and 1d for controlling the direction of conditioned air to be delivered from the indoor unit 1. The airflow direction controlling plates 1c vertically shift the airflow direction. The airflow direction controlling plates 1d horizontally shift the airflow direction.

The air in the indoor space is introduced by the indoor fan 1b through an inlet into the indoor unit 1, and arrives at the indoor heat exchangers 1a. The air then flows between fins provided on the indoor heat exchangers 1a, and is discharged through an outlet 1g. The air in the indoor space is subject to heat exchange with the refrigerant flowing in the refrigerant piping 1e, which is facilitated by the indoor heat exchangers 1a, resulting in a change in the temperature of the air. In the heating operation, the air delivered from the outlet 1g is warm air, because of the heat exchange with the refrigerant having a higher temperature than that of the air guided to the indoor heat exchangers 1a. In the cooling operation, the air delivered from the outlet 1g is cool air, because of the heat exchange with the refrigerant having a lower temperature than that of the air guided to the indoor heat exchangers 1a.

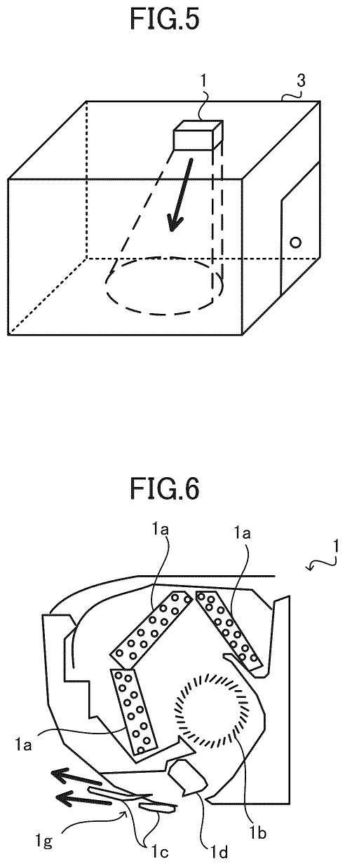

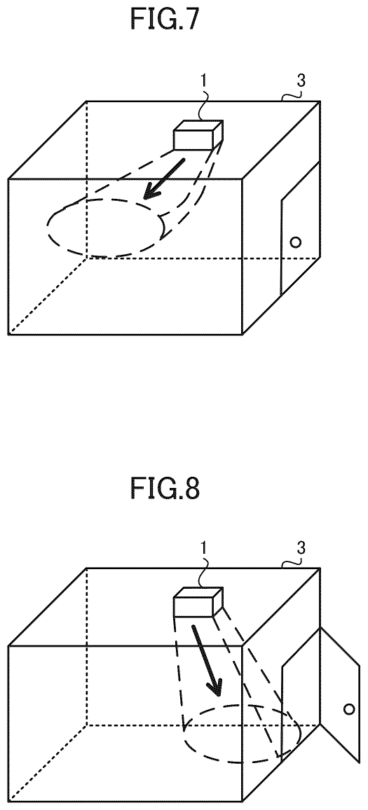

As illustrated in FIG. 4, when the airflow direction controlling plates 1c are directed downward, the air after the heat exchange with the refrigerant at the indoor heat exchangers 1a is delivered from the outlet 1g in a downward direction. In this case, as illustrated in FIG. 5, the air delivered from the indoor unit 1 arrives at an area near the floor of an indoor space 3, leading to air conditioning in the area near the floor. In contrast, as illustrated in FIG. 6, when the airflow direction controlling plates 1c are directed horizontally, the air after the heat exchange with the refrigerant at the indoor heat exchangers 1a is delivered from the outlet 1g in a horizontal direction. In this case, as illustrated in FIG. 7, the air delivered from the indoor unit 1 arrives at an area near the ceiling of the indoor space 3, leading to air conditioning in the area near the ceiling.

That is, the direction of the air to be delivered from the outlet 1g can be vertically shifted by adjusting the angles of the airflow direction controlling plates 1c. Also, the direction of the air to be delivered from the outlet 1g can be horizontally shifted by adjusting the angles of the airflow direction controlling plates 1d.

Such shift of the airflow direction can achieve direct delivery of warm or cool air to a user existing in the indoor space 3, and improve the thermal comfort level of the user. The thermal comfort level can be improved by delivering warm air to the feet of the user in the heating operation, or delivering cool air to the face or torso of the user in the cooling operation, for example. This shift can also achieve delivery of the air toward not an area including no user but an area including any user, resulting in energy-saving operations.

When the indoor space 3 is ventilated by opening a window or door, for example, the ventilation causes inward or outward leakage of heat and thus affects the thermal environment of the indoor space 3. The airflow control executed by the air conditioner 10 and the inward or outward leakage of heat from or to the outside provide a wind speed distribution and a temperature distribution in the indoor space 3. In an exemplary case where the warm air is delivered from the air conditioner 10 toward an opened door, as illustrated in FIG. 8, the delivered warm air exits the indoor space 3 through the door, and thus fails to increase the temperature of the indoor space 3. In contrast, in another exemplary case where the warm air is delivered toward the center of the indoor space 3, the warm air does not readily exit through the door, and thus succeeds to increase the temperature of the indoor space 3.

That is, the airflow control designates a destination area of the delivered air, and can thus avoid air delivery not contributing to temperature adjustment, leading to a reduction in the electric power consumption. An effective procedure to reduce the electric power consumption of the air conditioner 10 is selecting a destination area so as not to deliver warm or cool air to an area including no user, for example. Such control of the conditioned air to be delivered from the air conditioner 10 is called “airflow control”.

The airflow control can regulate the direction, temperature, and volume of the air to be delivered. The airflow control can adjust the time variation in the temperature distribution, wind speed distribution, and humidity in the indoor space 3, depending on the dimensions of the indoor space 3 and the position of a door, for example. As described above, the thermal environment of the indoor space 3 is adjusted by two controls: the refrigeration cycle control and the airflow control.

### Learning Phase

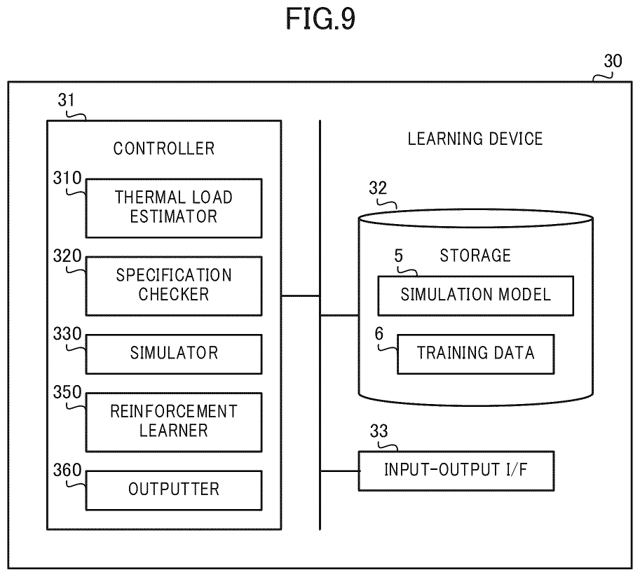

Referring back to FIG. 1, the learning device 30 learns the optimum control procedures for the air conditioner 10 in association with the thermal environments of the indoor space 3, by means of machine learning. The learning device 30 is achieved by an information processing device, such as personal computer, smartphone, or server on the Internet. As illustrated in FIG. 9, the learning device 30 includes a controller 31, a storage 32, and an input-output interface (I/F) 33.

The controller 31 includes a central processing unit (CPU), a read only memory (ROM), and a random access memory (RAM). The CPU may also be called a central processing unit, central calculation unit, processor, microprocessor, or microcomputer, for example. The CPU serves as a central calculation processor that executes processes and calculations related to control of the learning device 30. The CPU in the controller 31 reads the programs and data stored in the ROM, and performs comprehensive control of the learning device 30, using the RAM as a work area.

The storage 32 includes a non-volatile semiconductor memory, such as flash memory, erasable programmable ROM (EPROM), or electrically erasable programmable ROM (EEPROM), and serves as a so-called secondary storage or auxiliary storage. The storage 32 stores programs and data to be used in various processes executed by the controller 31. The storage 32 also stores data to be generated or acquired through various processes executed by the controller 31.

The storage 32 stores simulation models 5 and training data 6. The simulation models 5, which are described in detail below, are models designed to simulate a thermal environment of the indoor space 3. The training data 6, which is also described in detail below, is applied to calculation of a reward in the reinforcement learning executed by the learning device 30.

The input-output I/F 33 includes an interface that enables the learning device 30 to transmit and receive data to and from external modules. In a specific example, the input-output I/F 33 includes a communication module, such as local area network (LAN), or universal serial bus (USB), and a module for reading data from external storage devices.

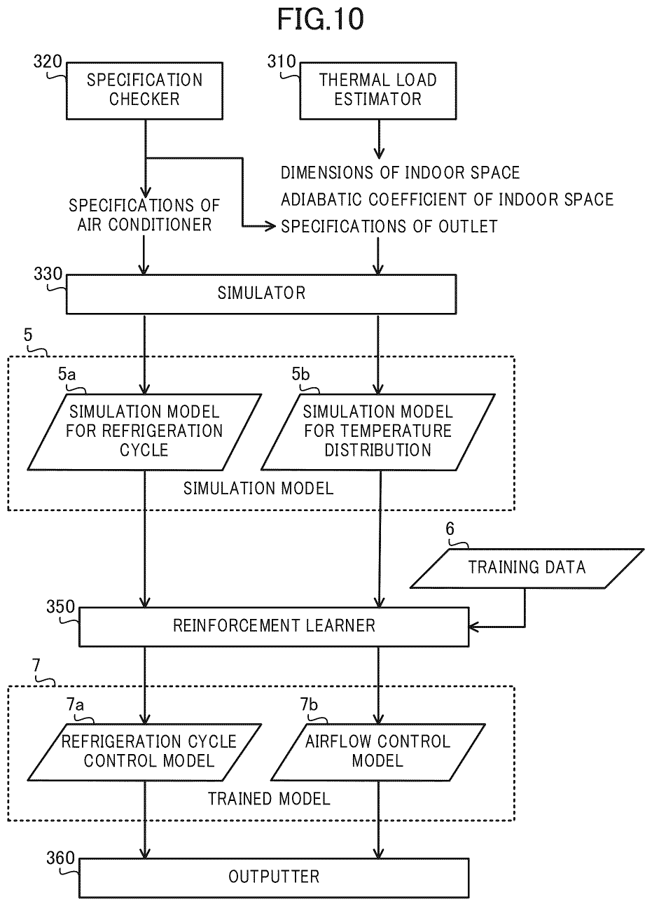

The controller 31 has functional components including a thermal load estimator 310, a specification checker 320, a simulator 330, a reinforcement learner 350, and an outputter 360. These functions are performed by software, firmware, or a combination of software and firmware. The software and firmware are described in the form of programs and stored in the ROM or the storage 32. The CPU reads and executes the programs stored in the ROM or the storage 32, and thus achieves the functions. The following describes the individual functions of the controller 31 with reference to FIG. 10.

### Thermal Load Estimator 310

The thermal load estimator 310 infers an adiabatic coefficient L of the indoor space 3, dimensions of the indoor space 3, and an ambient temperature θ₀, which are pieces of information related to thermal load on the indoor space 3. The adiabatic coefficient L of the indoor space 3 is a value indicating readiness of heat transfer between the indoor space 3 and the external space. The temperature θ(t) of the indoor space 3 at the time t satisfies an equation containing the heat capacity C of the indoor space 3, the adiabatic coefficient L of the indoor space 3, the ambient temperature θ₀, the operation capacity Q of the air conditioner 10, and the total amount Qᵤₛₑᵣₛ of heat produced by users existing in the indoor space 3, as is represented by Expression (1).

$$Expression 1$$

$$C \frac{d θ}{dt} = L ( θ - {θ}_{0} ) + ( Q + {Q}_{users} ) \qquad ( 1 )$$

The thermal load estimator 310 acquires images of the indoor space 3 with an image sensor installed at an appropriate site in the indoor space 3. The thermal load estimator 310 then estimates dimensions of the indoor space 3 on the basis of the images of the indoor space 3. The thermal load estimator 310 calculates a volumetric capacity V of the indoor space 3, from the dimensions of the indoor space 3 detected by the image sensor. After calculating the volumetric capacity V of the indoor space 3, the thermal load estimator 310 calculates a heat capacity C of the indoor space 3 using the expression “C=ρ×Cₚ×V”, where ρ indicates the density of the air and Cₚ indicates the specific heat of the air.

The thermal load estimator 310 detects the number of users existing in the indoor space 3 and an amount of movements of each user, with an image sensor. The thermal load estimator 310 then estimates a metabolic energy per user from the amount of movements of each user. The thermal load estimator 310 calculates the sum of the metabolic energies of the users, and thus estimates a total amount Qᵤₛₑᵣₛ of heat to be produced by the users existing in the indoor space 3.

The thermal load estimator 310 measures a temperature θ(t) of the indoor space 3 with a temperature sensor every predetermined period, and thus acquires a time variation in the temperature θ(t). The thermal load estimator 310 also estimates an ambient temperature θ₀ through measurement with a temperature sensor provided to the outdoor unit 2, or through retrieval of information, such as weather forecast information, from the Internet.

After estimating the heat capacity C of the indoor space 3, the total amount Qᵤₛₑᵣₛ of heat, the temperature θ(t), the time variation in the temperature θ(t), and the ambient temperature θ₀ as described above, the thermal load estimator 310 applies a system identification approach, such as least squares approach, to these pieces of data, and thus estimates an adiabatic coefficient L of the indoor space 3. The thermal load estimator 310 is an example of thermal load estimation means.

### Specification Checker 320

The specification checker 320 references the specifications of the air conditioner 10. The specifications of the air conditioner 10 mean the performances and capabilities of the air conditioner 10, for example. Specifically, the specifications of the air conditioner 10 include the capabilities of the refrigeration cycle, such as operation capacity of the air conditioner 10 and cost of performance (COP), and the capabilities of the airflow control, such as distance of delivery of the air from the indoor unit 1 and accuracy of destination of the air.

Such specifications of the air conditioner 10 are different among air conditioners 10. For example, the capabilities of the refrigeration cycle are defined by the components of the refrigeration cycle, such as the indoor heat exchangers 1a, the indoor fan 1b, the outdoor heat exchanger 2a, the outdoor fan 2b, the compressor 2c, and the expansion valve 2d. The capabilities of the airflow control are defined by the specifications of the outlet 1g of the indoor unit 1. The specifications of the outlet 1g specifically include the capabilities of the indoor fan 1b, and the sizes and the range of possible angles of the airflow direction controlling plates 1c and 1d.

The information on the specifications of the air conditioner 10 is required for simulation of a thermal environment of the indoor space 3 subject to the air conditioning executed by the air conditioner 10. A manufacturer of the air conditioner 10 thus associates the product model number of the air conditioner 10 with the information on the specifications of the indoor heat exchangers 1a, the outdoor heat exchanger 2a, the compressor 2c, the expansion valve 2d, and the outlet of the indoor unit 1, which is the specification information corresponding to this product model number, and causes the associated number and information to be stored into a database on the Internet. The specification checker 320 is an example of specification checking means.

### Simulator 330

The simulator 330 simulates a thermal environment of the indoor space 3 that is predicted to result from air conditioning of the indoor space 3 by the air conditioner 10 in a situation in which at least one of a state of the refrigeration cycle or a state of the indoor space is given. The simulator 330 generates trained models 7 in a simulated environment to be applied to the control of the air conditioner 10. The simulator 330 is an example of simulation means.

The simulator 330 generates simulation models 5 for simulating a thermal environment of the indoor space 3 through numerical calculations. Specifically, the simulator 330 generates (A) a simulation model 5a for the refrigeration cycle included in the air conditioner 10, and (B) a simulation model 5b for the temperature distribution in the indoor space 3, as the simulation models 5.

### (A) Simulation Model 5a for the Refrigeration Cycle

The simulation model 5a for the refrigeration cycle is a model aimed at simulating a response of the refrigeration cycle in a given state, through numerical calculations. Specifically, the simulation model 5a for the refrigeration cycle serves to calculate an operation capacity of the indoor unit 1 and a volume and temperature of the air delivered from the indoor unit 1 to the indoor space 3, on the basis of control values of the refrigeration cycle. The simulator 330 generates the simulation model 5a for the refrigeration cycle, on the basis of the specifications of the air conditioner 10 referenced by the specification checker 320.

Specifically, the control values of the refrigeration cycle are defined by the rotational speed of the indoor fan 1b, the rotational speed of the outdoor fan 2b, the frequency of the compressor 2c, the aperture of the expansion valve 2d, and the intake temperature of the indoor air introduced into the indoor unit 1. The operation capacity of the air conditioner 10 is an index indicating the intensity of air conditioning executable by the air conditioner 10. Specifically, the simulator 330 calculates, as the operation capacity of the air conditioner 10, a temperature of the condenser, a temperature of the evaporator, a frequency of the compressor 2c, an aperture of the expansion valve 2d, and a discharge superheat temperature.

As described above, in the heating operation, the condenser and the evaporator correspond to the indoor heat exchangers 1a and the outdoor heat exchanger 2a, respectively. In the cooling operation, the condenser and the evaporator correspond to the outdoor heat exchanger 2a and the indoor heat exchangers 1a, respectively. The discharge superheat temperature is also called a degree of superheat, and corresponds to the difference between the temperature of the refrigerant discharged from the compressor 2c and the temperature of the operating indoor heat exchangers 1a.

In more detail, the simulator 330 generates either one of (A1) a model based on differential equations and (A2) a system identification model, as the simulation model 5a for the refrigeration cycle. The simulator 330 may generate either one of these models as the simulation model 5a for the refrigeration cycle.

### (A1) Model Based on Differential Equations

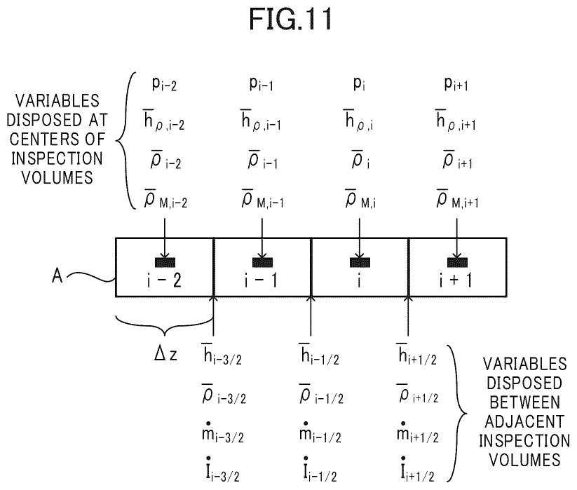

In order to establish a model based on differential equations, the simulator 330 divides the refrigerant piping 1e, in which the refrigerant flows, into multiple units of inspection volumes, as illustrated in FIG. 11. Each of the inspection volumes is a micro-volume element having a size defined by a cross-sectional area A and a length Δz.

The simulator 330 calculates, for each inspection volume, an average density ρ of the refrigerant, a flow rate G of the refrigerant, a density-averaged enthalpy hₚ, a flow-rate-averaged enthalpy h, and an average shear force τ_{M} at the walls of the inspection volume, in accordance with the governing equations of the refrigerant flow represented by Expressions (2), (3), and (4). Expression (2) corresponds to the equation for conservation of mass, Expression (3) corresponds to the equation for conservation of energy, and Expression (4) corresponds to the equation for conservation of momentum. In Expressions (2), (3), and (4), each of the symbols of the average density ρ, the density-averaged enthalpy hₚ, the flow-rate-averaged enthalpy h, and the average shear force τ_{M} is provided with an upper bar “ ” indicating an average.

$$Expression 2$$

$$\frac{\overline{ρ} A}{dt} + \to \frac{\partial }{z} ( GA ) = 0 \qquad ( 2 )$$

$$Expression 3$$

$$\frac{\partial }{\partial t} ( \overline{ρ} \overline{{h}_{ρ}} A ) + \frac{\partial }{\partial z} ( G \overline{h} A ) = {Pq}_{w}^{″} + \frac{\partial }{\partial t} ( pA ) \qquad ( 3 )$$

$$Expression 4$$

$$\frac{\partial }{\partial t} ( GA ) + \frac{\partial }{\partial z} ( \frac{{G}^{2} \overline{h} A}{\overline{{ρ}_{M}}} ) = A \frac{\partial p}{\partial z} - \overline{{τ}_{w}} p - \overline{ρ} gA sin ( θ ) \qquad ( 4 )$$

The simulator 330 discretizes these governing equations by the finite difference method or the finite volume method, and numerically integrates the simultaneous differential equations. The number of divided inspection volumes is defined depending on the calculation speed of the learning device 30, so as to maintain a sufficiently short period of the simulation.

### (A2) System Identification Model

In order to establish a system identification model, the simulator 330 generates a state space model through system identification from pieces of data measured in the refrigeration cycle. The state space model is represented by Expressions (5) and (6).

$$Expression 5$$

$${X}_{t + 1} = A {X}_{t} + b {u}_{t} \qquad ( 5 )$$

$$Expression 6$$

$${Y}_{t + 1} = C {X}_{t} + d {u}_{t} s \qquad ( 6 )$$

Yₜ, which indicates an observed variable in the state space model, is a vector having components made of the temperature of the condenser, the temperature of the evaporator, and the discharge superheat temperature at the time t. uₜ is a vector having components made of the rotational speed of the indoor fan 1b, the rotational speed of the outdoor fan 2b, the frequency of the compressor 2c, and the aperture of the expansion valve 2d at the time t. Xₜ is a matrix indicating the internal state at the time t. A, b, C, and d indicate matrices and vector coefficients serving as parameters of the state space model.

The simulator 330 generates such a state space model as the simulation model 5a for the refrigeration cycle. The simulator 330 executes system identification in order to determine values of the coefficients of the state space model. Specifically, the simulator 330 acquires, from the air conditioner 10, measured pieces of data on the temperature of the condenser, the temperature of the evaporator, the frequency of the compressor 2c, and the aperture of the expansion valve 2d. The simulator 330 then defines the matrices and vector coefficients serving as parameters of the state space model on the basis of the measured pieces of data. The simulator 330 in this process implements a system identification method, such as prediction error method or subspace method. After determination of values of A, b, C, and d, the simulator 330 can calculate an observed variable Yₜ defined by the input uₜ at each time t.

The simulator 330 implements the simulation model 5a for the refrigeration cycle generated as described above, and thus simulates a thermal environment of the indoor space 3 that is predicted to result from air conditioning of the indoor space 3 by the air conditioner 10 in a situation in which a state of the refrigeration cycle is given.

### (B) Simulation Model 5b for the Temperature Distribution

The simulation model 5b for the temperature distribution is a model aimed at simulating a temperature distribution in the indoor space 3 in a given state, through numerical calculations. Specifically, the simulation model 5b for the temperature distribution serves to calculate a temperature distribution of the air in the indoor space 3, on the basis of the dimensions and heat insulation performance of the indoor space 3, and the volume and direction of the air delivered from the indoor unit 1 to the indoor space 3.

The simulator 330 employs the dimensions and the adiabatic coefficient L estimated by the thermal load estimator 310, as the dimensions and heat insulation performance of the indoor space 3. The simulator 330 also employs information on the specifications of the outlet 1g, among the specifications of the air conditioner 10 referenced by the specification checker 320. Specific examples of the specifications of the outlet 1g include the capabilities of the indoor fan 1b, the sizes of the airflow direction controlling plates 1c and 1d, and the ranges of possible angles of the airflow direction controlling plates 1c and 1d. That is, the simulator 330 generates the simulation model 5b for the temperature distribution in the indoor space 3, on the basis of the adiabatic coefficient L and the dimensions of the indoor space estimated by the thermal load estimator 310, and the specifications of the outlet 1g of the indoor unit 1 referenced by the specification checker 320.

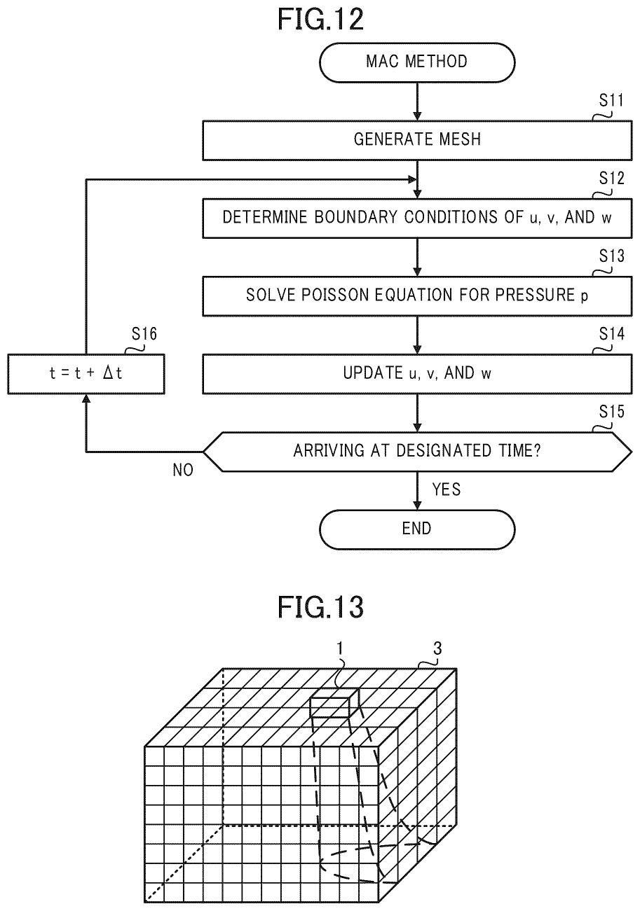

In more detail, the simulator 330 implements a numerical calculation procedure for simulating a temperature distribution. A typical example of the procedure is the marker and cell (MAC) method, which is a kind of finite difference method. The MAC method is described below with reference to FIG. 12.

At the start of the MAC method, the simulator 330 generates a mesh that defines calculation units in the indoor space 3 (Step S11). The simulator 330 generates a numerical calculation model illustrated in FIG. 13, for example. Specifically, the simulator 330 depicts walls enclosing the indoor unit 1 as a numerical calculation model, on the basis of the dimensions of the indoor space 3. The simulator 330 then provides a mesh to the depicted numerical calculation model.

Evaluation of effects of the simulated airflow control requires calculation of volumes of the air delivered to the individual portions of the body of a user existing in the indoor space 3. The mesh thus must have a resolution of approximately 20 cm so as to partition the individual portions of the body of the user from each other. Specifically, the indoor space 3 is assumed to have a size of 7.2 m in width, 7.2 m in depth, and 1.8 m in height. This indoor space 3, provided with a mesh having a resolution of 20 cm, has 36 cells in width, 36 cells in depth, and 9 cells in height. The total number N of cells is thus 11,664. The model has 5×N variables to be solved, assuming a regular grid having a pressure p, a three-dimensional airflow vector V=(u, v, w), and a temperature T in the same cell.

Referring back to FIG. 12, the simulator 330, after generating a mesh, determines boundary conditions of the three-dimensional airflow vector V=(u, v, w) (Step S12). Specifically, the simulator 330 determines a volume, direction, and temperature of the air delivered from the outlet 1g, a volume, direction, and temperature of the intake air introduced into the inlet, and heat transfer conditions of the walls. The upper and lower limits of the volume, direction, and temperature of the delivered air and the intake air are defined by the specifications of the outlet 1g and the inlet. The heat transfer conditions of the walls are defined by the adiabatic coefficient of the walls.

In the case where the direction, volume, and temperature of the delivered air vary with time during the simulation, or the case where the heat transfer conditions vary with time due to ventilation that changes the aperture of a window or door provided on the walls, the boundary conditions must be accordingly varied. The process of varying the boundary conditions requires an access to the memory that stores the variables of the individual cells. The access to the memory in Step S12 needs a time, which is, however, sufficiently shorter than that of the floating-point arithmetic operations in Steps S13 and S14 and is thus ignorable.

After determining the boundary conditions of the airflow vector V, the simulator 330 solves the Poisson equation for the pressure p (Step S13). Specifically, the simulator 330 calculates the Poisson equation for the pressure p represented in Expression (7). D is a variable represented by the equation “D=∂u/∂x+∂v/∂y+∂w/∂z”.

$$Expression 7$$

$$Δ p = - ∇ \cdot ( V \cdot ∇ ) V + D / Δ t \qquad ( 7 )$$

Expression (7) can be converted into N×N simultaneous difference equations, because the pressure p has N variables in the whole cells. The simulator 330 repeatedly calculates the simultaneous equations by the successive over-relaxation (SOR) method, for example. The simultaneous equations require ten times of repeated calculations to be solved. Each of the repeated calculations is estimated to involve 10×N times of floating-point arithmetic operations. Step S13 is thus estimated to involve 100×N times of floating-point arithmetic operations.

After calculating the pressure p, the simulator 330 updates the airflow vector V=(u, v, w) (Step S14). Specifically, the simulator 330 applies the pressure p calculated in Step S14 to the temporal update of the time-evolution equation of the airflow vector V=(u, v, w) represented by Expression (8), and the time-evolution equation of the temperature T represented by Expression (9). Assuming that the temporal update of a single variable involves ten times of floating-point arithmetic operations, Step S14 is estimated to involve approximately 40×N times of floating-point arithmetic operations.

$$Expression 8$$

$$\frac{δ V}{\partial t} + ( V \cdot ∇ ) V = - ∇ p + \frac{1}{Re} Δ V \qquad ( 8 )$$

$$Expression 9$$

$$\frac{δ T}{\partial t} + ( V \cdot ∇ ) T = - \frac{1}{Re Pr} Δ T \qquad ( 9 )$$

The simulator 330 thus calculates pressures p, airflow vectors V=(u, v, w), and temperatures T for all the cells at the time t in Steps S12 to S14. The simulator 330 then determines whether the time t has reached a designated time (Step S15). When the time t has not reached the designated time (Step S15; NO), the simulator 330 updates the time t to the time t+Δt (Step S16).

The simulator 330 then returns to Step S12, and recalculates values p, u, v, w, and T at the time t+Δt in Steps S12 to S14. The simulator 330 thus repeats Steps S12 to S14 until when the time t reaches the designated time, and calculates values p, u, v, w, and T at multiple time points having a time interval of Δt. When the time t has finally reached the designated time (Step S15; YES), the simulator 330 terminates the MAC method illustrated in FIG. 12.

The temporal update in Steps S12 to S14 is estimated to involve 140×N times of floating-point arithmetic operations in each cycle. This calculation will diverge without convergence in the case of an excessively long time interval Δt. A known indication of the time interval Δt is calculated such that the Courant number C represented by Expression (10) is equal to or lower than 1.0.

$$Expression 10$$

$$C = \frac{u Δ t}{Δ x} \qquad ( 10 )$$

In an exemplary case where the air conditioner 10 is a room air conditioner, the speed of the delivered air is approximately 5 [m/s]. Assuming that each cell has a size of 20 [cm], the time interval Δt that provides the Courant number equal to 1 is calculated by the equation “Δt=1÷(5÷0.2)=0.04 [s]”. In the case of calculations of a temperature distribution and a wind speed distribution in the indoor space 3 one hour later, the time interval Δt of 0.04 [s] results in 9.0×10⁵ cycles of the temporal update. These calculations involve the total times M of floating-point arithmetic operations represented by the equation “M=(140×N)×(9.0×10⁵)=1.3×10⁸×N to 1.4×10¹²”. Such an amount of calculations is acceptable in a calculator provided in a server, or a smartphone or PC owned by the user, for example.

The simulator 330 implements the simulation model 5b for the temperature distribution generated as described above, and thus simulates a thermal environment of the indoor space 3 that is predicted to result from air conditioning of the indoor space 3 by the air conditioner 10 in a situation in which a state of the indoor space 3 is given.

### Training Data 6

Referring back to FIG. 10, the training data 6 stored in the storage 32 is applied to calculations of rewards in the reinforcement learning executed by the reinforcement learner 350, and indicate target values of the thermal environment of the indoor space 3. Specifically, the training data 6 indicate chronological patterns of temperatures preferred by a user as the target values.

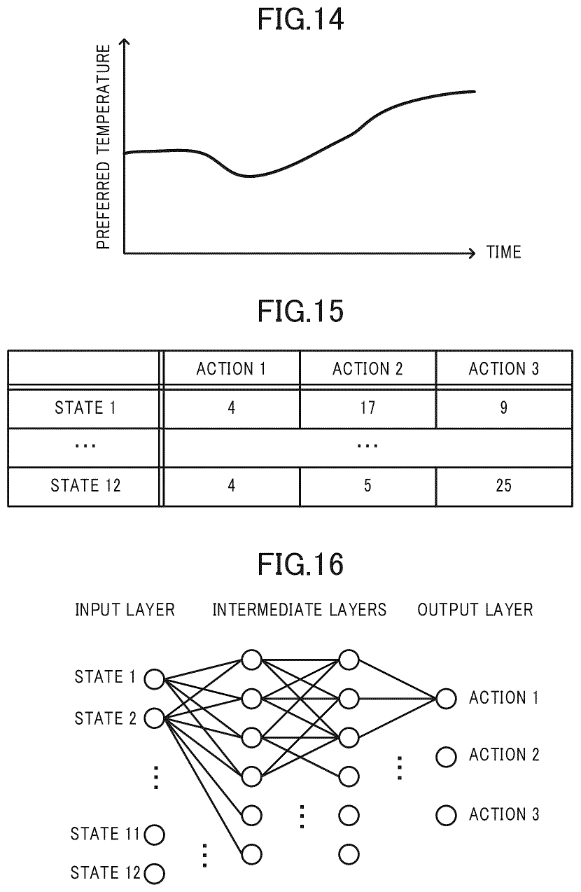

For example, as illustrated in FIG. 14, the training data 6 contains a piece of data of temperatures preferred by a user at the individual time points in a day. The training data 6 contains, in addition to the piece of data indicating preferred temperatures, a piece of data indicating a chronological pattern of humidities preferred by a user. The training data 6 containing such pieces of data is generated in advance on the basis of measured pieces of data collected from multiple users, and stored into the storage 32.

The thermal environments that users feel thermally comfortable are different among the users. The comfort level of the thermal environment depends on factors including a temperature and humidity of the indoor space 3, metabolic energies of the users, and amounts of clothing of the users. The metabolic energies of the users are determined by the attributes of the users, such as age, sex, and amount of movements. These factors related to a user at a certain time of day are different from those of the same user at another time of day, and the temperature and humidity preferred by the user are also different depending on the time of day.

For example, users tend to prefer a relatively low temperature in the cooling operation during the daytime in which the users are active and have high metabolic energies. In contrast, the users tend to prefer a relatively high temperature in the cooling operation during the nighttime in which the users are sleeping. A user, who works near the air conditioner 10 in the daytime and sleeps away from the air conditioner 10 in the nighttime, has different demands for destinations and volumes of the air to be delivered from the air conditioner 10 depending on the time of day. Users having various lifestyles change their clothing at different timings in the indoor space 3, and the amounts of clothing of the users also vary depending on the time of day.

Furthermore, the number of users existing in the indoor space 3 at a certain time of day may be different from that in the same indoor space 3 at another time of day. The air conditioner 10 is desired to provide a lower operation capacity during the absence of a user, but an excessively low operation capacity may cause the user to suffer from an excessively high or low temperature of room when the user returns to the indoor space 3. That is, the temperatures and humidities preferred by users vary depending on the time of day or depending on timings. The training data 6 contains pieces of data of temperatures and humidities preferred by users at various time points, and can thus serve as target values of the thermal environment associated with various states of the refrigeration cycle and various states of the indoor space 3.

Although the time variations in the temperatures and humidities preferred by users are different among the individual users, the time variations in the temperatures and humidities preferred by users having similar attributes show similar tendencies, according to some researches of data collected from a large number of users. If the refrigeration cycle control and the airflow control are executed so as to follow a piece of chronological data indicating a statistically analyzed chronological pattern of the temperatures and humidities preferred by the users, these controls can be established as generic controls suitable for the temperatures and humidities preferred by any type of users. The refrigeration cycle control and the airflow control, however, have strong non-linear properties, and make it difficult to design models by a procedure based on a control theory, such as proportional-integral-differential (PID) control or model predictive control. In view of these situations, the learning device 30 executes reinforcement learning of the optimum control procedures on the basis of the actual pieces of data.

### Reinforcement Learner 350

Referring back to FIG. 10, the reinforcement learner 350 executes reinforcement learning that employs, as a reward, a value based on the thermal environment simulated by the simulator 330. The reinforcement learner 350 thus generates, from at least one of a state of the refrigeration cycle and a state of the indoor space 3, trained models 7 aimed at inferring control values of the air conditioner 10 suitable for the state. The reinforcement learner 350 is an example of reinforcement learning means.

The trained models 7 are models trained based on a reinforcement learning algorithm. The trained models 7 cause the air conditioning control device 50 to infer control values of the air conditioner 10 from at least one of a state of the refrigeration cycle and a state of the indoor space 3. Each of the trained models 7 is made of a Q-table or a neural network, as is described below. The reinforcement learner 350 generates (A) a refrigeration cycle control model 7a, and (B) an airflow control model 7b, as the trained models 7.

The refrigeration cycle control model 7a is a model aimed at inferring control values of the refrigeration cycle from the state of the refrigeration cycle. The refrigeration cycle control model 7a, when receiving input of a state of the refrigeration cycle, outputs control values of the refrigeration cycle. The state of the refrigeration cycle is specifically defined by the temperature of the indoor heat exchangers 1a, the temperature of the outdoor heat exchanger 2a, the frequency of the compressor 2c, the aperture of the expansion valve 2d, and the discharge superheat temperature. The control values of the refrigeration cycle are specifically values for control of the rotational speed of the indoor fan 1b, the rotational speed of the outdoor fan 2b, the frequency of the compressor 2c, and the aperture of the expansion valve 2d.

The airflow control model 7b is a model aimed at inferring control values of airflow in the indoor space 3 from the state of the indoor space 3. The airflow control model 7b, when receiving input of a state of the indoor space 3, outputs control values of the airflow in the indoor space 3. The state of the indoor space 3 is specifically defined by the direction of the air delivered from the indoor unit 1 to the indoor space 3, the temperature distribution in the indoor space 3, and the position of a user in the indoor space 3. The control values of the airflow are specifically values for control of the volume, direction, and temperature of the delivered air.

The reinforcement learner 350 executes reinforcement learning of the refrigeration cycle control and the airflow control, using the simulation model 5a for the refrigeration cycle and the simulation model 5b for the temperature distribution, and thus generates trained models 7. In the reinforcement learning, the reinforcement learner 350 executes reinforcement learning that employs, as a reward, a value based on the thermal environment simulated by the simulator 330, on the basis of the training data 6 stored in the storage 32. Specifically, the reinforcement learner 350 compares the temperature or humidity of the indoor space 3, which is an index indicating the thermal environment simulated by the simulator 330, with the target value defined in the training data 6, and executes reinforcement learning that gives a higher reward for the temperature or humidity closer to the target value.

In more detail, the reinforcement learner 350 executes three steps: (i) selecting an action, (ii) calculating a reward, and (iii) updating the state function. These steps allow the reinforcement learner 350 to update the state function serving as a control logic and thus learn the optimum control procedures. In the following description, the state at the time t is indicated by st, the action is indicated by at, and the reward value is indicated by rₜ. The state function is represented by a function Q(sₜ, aₜ) of which the input variables are the state sₜ and the action aₜ.

The reinforcement learner 350 generates each of (A) the refrigeration cycle control model 7a and (B) the airflow control model 7b made of (I) a Q-table or (II) a neural network.

The Q-table manages Q-values each indicating a value to be given as a result of selection of a certain action in a certain state. Specifically, a Q-table like that illustrated in FIG. 15 defines Q-values to be given as a result of selection of actions aₜ in states sₜ, and thus serves as a state function Q(sₜ, aₜ). The Q-table illustrated in FIG. 15 defines states 1 to 12 as the states sₜ, actions 1 to 3 as the actions aₜ, and Q-values for the individual combinations of these states and actions, for example. For the model made of such a Q-table, the reinforcement learner 350 implements a reinforcement learning algorithm, such as Q-learning algorithm or Sarsa algorithm.

Examples of the neural network include a deep neural network and a convolutional neural network (CNN). Specifically, a neural network like that illustrated in FIG. 16 includes an input layer, intermediate layers, and an output layer. The neural network, when receiving input of the variables associated with the state sₜ at the input layer, outputs variables associated with the action aₜ providing the highest value at the output layer. For the model made of such a neural network, the reinforcement learner 350 implements a deep reinforcement learning algorithm, such as deep Q-network (DQN) algorithm. In this case, the reinforcement learner 350 stores values associated with variations in the environment caused by the actions aₜ of an agent in the states sₜ and learns the action aₜ providing the highest value in the input state sₜ, by means of the neural network.

### (AI) Generation of the Refrigeration Cycle Control Model 7a Made of a Q-Table

The reinforcement learning requires definition of states sₜ and actions aₜ at the time t. The states of the refrigeration cycle among the states sₜ at the time t are hereinafter referred to as “states sᵢ (i=1, 2, . . . )”, and the actions of the refrigeration cycle control among the actions aₜ at the time t are referred to as “actions aᵢ (i=1, 2, . . . )”. The reinforcement learner 350 defines the state sᵢ of the refrigeration cycle, using a temperature T_{c} of the condenser, a temperature Tₑ of the evaporator, a frequency C of the compressor 2c, an aperture Φ of the expansion valve 2d, and a discharge superheat temperature T_{SH}.

Specifically, the reinforcement learner 350 determines the lower and upper limits of each of the variables including the temperature T_{c} of the condenser, the temperature Tₑ of the evaporator, the frequency C of the compressor 2c, the aperture Φ of the expansion valve 2d, and the discharge superheat temperature T_{SH}, as the state sᵢ of the refrigeration cycle control. The reinforcement learner 350 then divides the range of each variable into a finite number of subranges ranging from the lower limit to the upper limit, and defines the state sᵢ by the number of subrange containing the value of the variable.

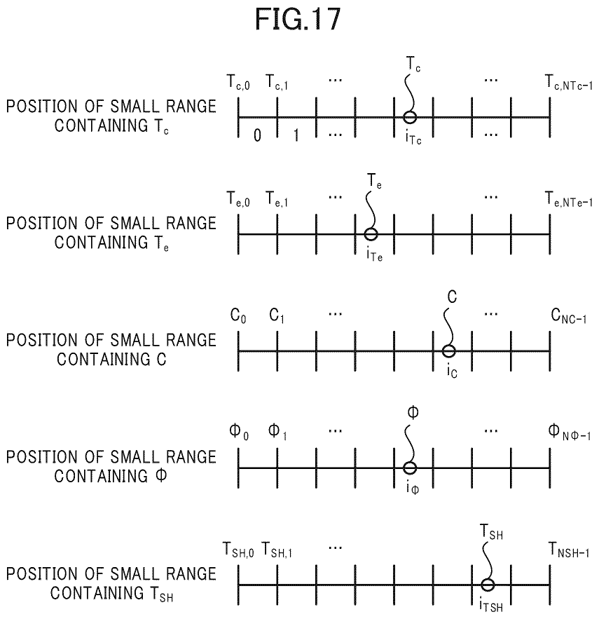

In more detail, the reinforcement learner 350 defines states sᵢ of the refrigeration cycle control, as illustrated in FIG. 17. The reinforcement learner 350 determines a possible range of the temperature T_{c} of the condenser defined between the lower limit of T_{c, 0} and the upper limit of T_{c, NTc-1}. The reinforcement learner 350 then divides this range defined between the lower and upper limits, into NTc subranges: a subrange 1 (T_{c, 0}≤T_{c}<T_{c, 1}), a subrange 2 (T_{c, 1}≤T_{c}<T_{c, 2}), . . . , and a subrange N_{Tc} (T_{c}, N_{Tc-2}≤T_{c}<T_{c, NTc-1}).

The reinforcement learner 350 finds what number of subrange counted from the lower limit of the divided N_{Tc} number of subranges contains the temperature T_{c} of the condenser, and determines the number of the subrange containing the temperature T_{c} of the condenser to be i_{Tc}. Also, the reinforcement learner 350 divides the possible range of the temperature Tₑ of the evaporator into N_{Te} subranges, the possible range of the frequency C of the compressor 2c into N_{C} subranges, the possible range of the aperture Φ of the expansion valve 2d into N_{Φ} subranges, and the possible range of the discharge superheat temperature T_{SH} into N_{TSH} subranges, and determines the corresponding numbers to be i_{Te}, i_{C}, i_{Φ}, and i_{TSH}, respectively. In FIG. 17, the temperature T_{c} of the condenser is contained in the i_{Tc}-th subrange, the temperature Tₑ of the evaporator is contained in the i_{Te}-th subrange, the frequency C of the compressor 2c is contained in the i_{C}-th subrange, the aperture Φ of the expansion valve 2d is contained in the i^{Φ}-th subrange, and the discharge superheat temperature T_{SH} is contained in the i_{TSH}-th subrange.

The reinforcement learner 350 defines each of the states sᵢ using the numbers of subranges for the individual variables. The numbers of subranges for the variables have N_{Tc}×N_{Te}×N_{C}×N^{Φ}×N_{TSH} possible combinations in total. The reinforcement learner 350 provides each of these combinations with a reference symbol to define the states sᵢ (i=1, 2, . . . , N_{Tc}×N_{Te}×N_{C}×N^{Φ}×N_{TSH}). Specifically, in the case of the temperature T_{c} of the condenser contained in the i_{Tc}-th subrange, the temperature Tₑ of the evaporator contained in the i_{Te}-th subrange, the frequency C of the compressor 2c contained in the i_{C}-th subrange, the aperture (of the expansion valve 2d contained in the i^{Φ}-th subrange, and the discharge superheat temperature T_{SH} contained in the i_{TSH}-th subrange, the state is provided with a reference symbol i represented by the equation “i=i_{Tc}+(i_{Te}−1)×N_{Tc}+(i_{C}−1)×N_{Tc}×N_{Te}+(i_{Φ}−1)×N_{Tc}×N_{Te}×N_{C}+(i_{TSH}−1)×N_{Tc}×N_{Te}×N_{C}×N_{Φ}.”

The reinforcement learner 350 then defines the actions aᵢ of the refrigeration cycle control that can be taken in the individual states sᵢ of the refrigeration cycle. Specifically, the reinforcement learner 350 defines the actions aᵢ (i=1, 2, . . . , 8) of the refrigeration cycle control as listed below.
Action a₁: to increment the rotational speed of the indoor fan 1b by ΔFAN_{indoor}
Action a₂: to decrement the rotational speed of the indoor fan 1b by ΔFAN_{indoor}
Action a₃: to increment the rotational speed of the outdoor fan 2b by ΔFAN_{outdoor}
Action a₄: to decrement the rotational speed of the outdoor fan 2b by ΔFAN_{outdoor}
Action a₅: to increment the frequency of the compressor 2c by ΔC
Action a₆: to decrement the frequency of the compressor 2c by ΔC
Action a₇: to increment the aperture of the expansion valve 2d by ΔΦ
Action a₈: to decrement the aperture of the expansion valve 2d by ΔΦ

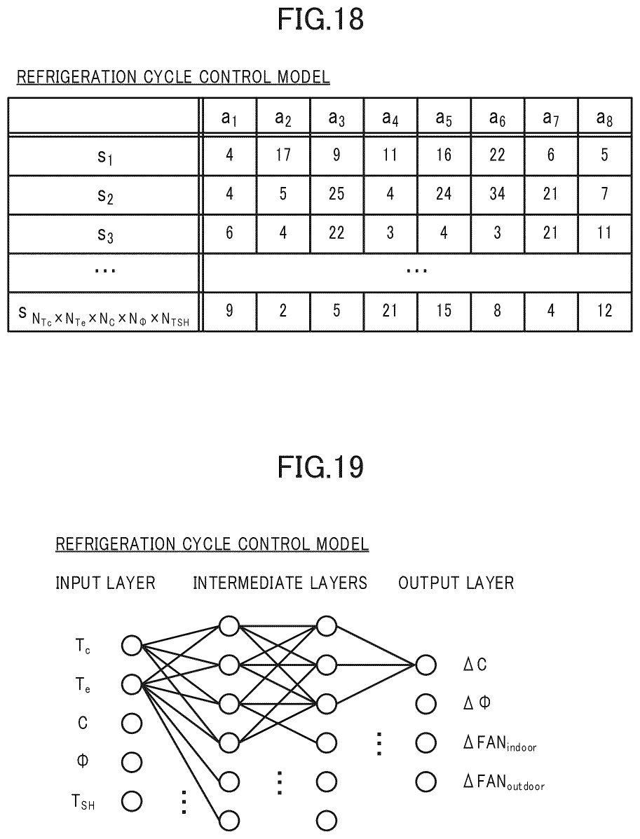

The reinforcement learner 350 thus defines the actions aᵢ of the refrigeration cycle control, using an amount of change in the rotational speed of the indoor fan 1b, an amount of change in the rotational speed of the outdoor fan 2b, an amount of change in the frequency of the compressor 2c, and an amount of change in the aperture of the expansion valve 2d. On the basis of the states sᵢ (i=1, 2, . . . , N_{Tc}×N_{Te}×N_{C}×N_{Φ}×N_{TSH}) and the actions aᵢ (i=1, 2, . . . , 8) defined as described above, the reinforcement learner 350 generates a Q-table for the refrigeration cycle control, like that illustrated in FIG. 18.

### (AII) Generation of the Refrigeration Cycle Control Model 7a Made of a Neural Network

In order to establish a refrigeration cycle control model 7a made of a neural network, the reinforcement learner 350 generates a neural network like that illustrated in FIG. 19 to constitute the refrigeration cycle control model 7a.

The individual nodes of the input layer in the first column of the neural network receive the variables indicating the state sᵢ of the refrigeration cycle at the time t, that is, the temperature T_{c} of the condenser, the temperature Tₑ of the evaporator, the frequency C of the compressor 2c, the aperture Φ of the expansion valve 2d, and the discharge superheat temperature T_{SH}. In response to the input variables, the individual nodes of the output layer in the last column of the neural network output variables indicating an action aᵢ at the time t, that is, an amount ΔFAN_{indoor} of change in the rotational speed of the indoor fan 1b, an amount ΔFAN_{outdoor} of change in the rotational speed of the outdoor fan 2b, an amount ΔC of change in the frequency of the compressor 2c, and an amount ΔΦ of change in the aperture of the expansion valve 2d.

The values input into or output from the neural network may be normalized by an appropriate value. These normalized values may be reconverted into the original values in the actual control of the refrigeration cycle. The neural network may include any total number of intermediate layers, which are refined through preliminary researches of efficiencies of the reinforcement learning.

### (BI) Generation of the Airflow Control Model 7b Made of a Q-Table

The reinforcement learning for generation of an airflow control model 7b also requires definition of states sₜ and actions aₜ at the time t. The states of the indoor space 3 among the states sₜ at the time t are hereinafter referred to as “states sⱼ (j=1, 2, . . . )”, and the actions of the airflow control among the actions aₜ at the time t are referred to as “aⱼ (j=1, 2, . . . )”. The reinforcement learner 350 defines the states sⱼ of the indoor space 3 at the time t, using the temperatures at multiple sites in the indoor space 3, and the angle of the air delivered from the indoor unit 1 to the indoor space 3.

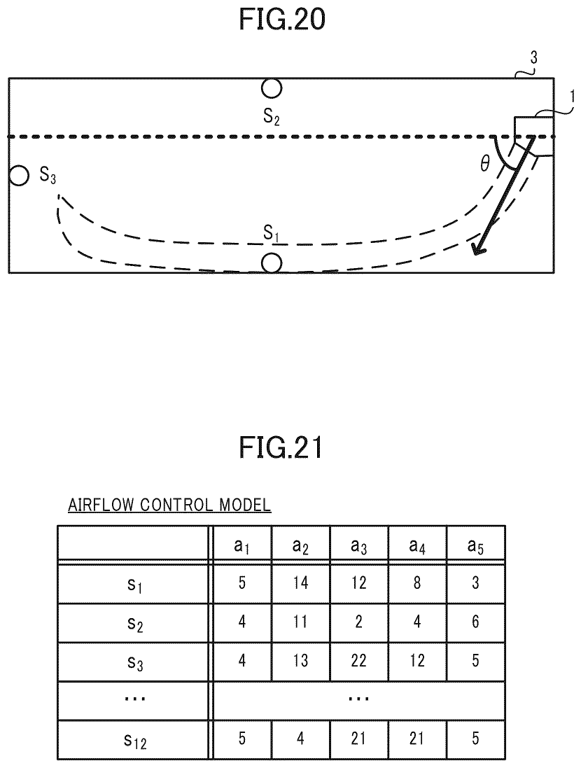

Specifically, the reinforcement learner 350 employs, as the states sⱼ of the indoor space 3, the temperatures T_{S1}, T_{S2}, and T_{S3} at three measurement sites S1, S2, and S3 in the indoor space 3, and the vertical airflow angle θ of the indoor unit 1, as illustrated in FIG. 20. The airflow angle θ can be measured by recording the angles of stepping motors for driving the airflow direction controlling plates 1c and 1d in the indoor unit 1.

The temperatures T_{S1}, T_{S2}, and T_{S3} at the measurement sites S1, S2, and S3, when aligned in the descending order (1^{st}, 2^{nd}, and 3^{rd}) of the temperature, have 6 (=3!) permutations. In addition, the airflow angles θ are classified into two patterns: an upper-side airflow (θ<45°) and a lower-side airflow (θ≥45°). The reinforcement learner 350 associates any state sⱼ in the indoor space 3 with any of the states s₁ to s₁₂ defined by 12 (=6×2) patterns, which correspond to the combinations of the six permutations of the temperatures T_{S1}, T_{S2}, and T_{S3} and the two patterns of the airflow angles θ.

The reinforcement learner 350 then defines the actions aⱼ of the airflow control that can be taken in the individual states sⱼ of the airflow in the indoor space 3. Specifically, the reinforcement learner 350 defines actions aⱼ at the time t+1 as listed below, where θₜ indicates an angle of the delivered air in the state sⱼ at the time t.
Action aᵢ: to increase the airflow angle (θₜ₊₁=θₜ+Δθ)
Action a₂: to decrease the airflow angle (θₜ₊₁=θₜ−Δθ)
Action a₃: to maintain the airflow angle (θₜ₊₁=θₜ)
Action a₄: to shift the airflow direction leftward (φₜ₊₁=φₜ+Δφ)
Action a₅: to shift the airflow direction rightward (Φₜ₊₁=φₜ−Δφ)

Δθ indicates a vertical angle of adjustment of the airflow angle, and is defined to be 5°, for example. Δφ indicates a horizontal angle of adjustment of the airflow angle, and is defined to be 5°, for example. The reinforcement learner 350 selects one of these five actions aᵢ to a₅ for the state sⱼ of the indoor space 3.

The reinforcement learner 350 thus defines the actions aⱼ of the airflow control at the time t, using the direction of the air delivered from the indoor unit 1 to the indoor space 3. On the basis of the states sⱼ (j=1, 2, . . . , 12) and the actions aⱼ (j=1, 2, . . . , 5) defined as described above, the reinforcement learner 350 generates a Q-table for the airflow control, like that illustrated in FIG. 21.

### (BII) Generation of the Airflow Control Model 7b Made of a Neural Network

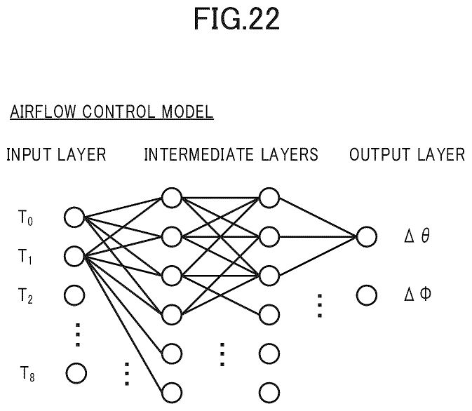

In order to establish an airflow control model 7b made of a neural network, the reinforcement learner 350 generates a neural network like that illustrated in FIG. 22 to constitute the airflow control model 7b. Specifically, the individual nodes of the input layer in the first column of the neural network receive input variables, that is, the temperatures Tᵢ at multiple sites in the indoor space 3. The temperatures Tᵢ at multiple sites indicate the temperatures at 64 (8×8) sites on the floor surface of the indoor space 3, for example. In response to the input variables, the individual nodes of the output layer in the last column of the neural network output angles Δθ and Δφ for adjustment of the direction of the delivered air.

The values input into or output from the neural network may be normalized by an appropriate value. For example, the neural network may receive an input value Tᵢ/Tₘₐₓ generated by normalizing each temperature Tᵢ by its maximum value Tₘₐₓ. These normalized values may be reconverted into the original values in the actual airflow control. The neural network may include any total number of intermediate layers, which are refined through preliminary researches of efficiencies of the reinforcement learning.

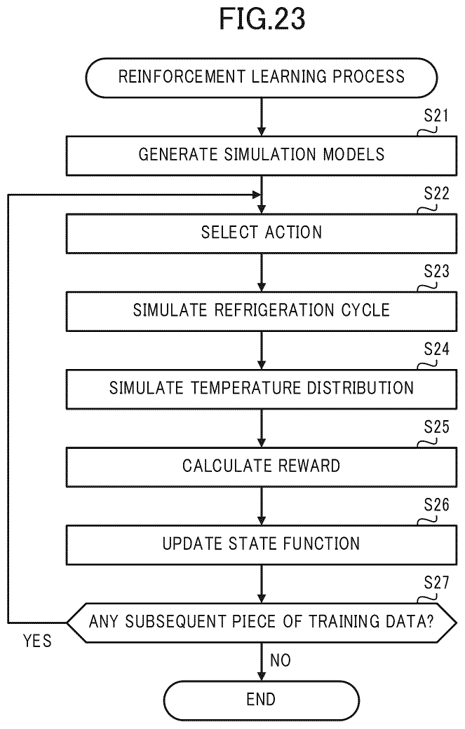

The following describes a reinforcement learning process executed by the learning device 30, with reference to FIG. 23. The controller 31 of the learning device 30 executes the reinforcement learning process illustrated in FIG. 23, after the installation of the air conditioner 10 in the indoor space 3.

At the start of the reinforcement learning process, the simulator 330 generates simulation models 5 (Step S21). Specifically, the simulator 330 generates a simulation model 5a for the refrigeration cycle and a simulation model 5b for the temperature distribution, on the basis of the thermal load of the indoor space 3 estimated by the thermal load estimator 310, and the specifications of the air conditioner 10 referenced by the specification checker 320.

After generation of the simulation models 5, the reinforcement learner 350 selects an action aₜ to be taken in a situation in which a state sₜ at the time t is given (Step S22). Specifically, the reinforcement learner 350 selects one of the above-mentioned actions aᵢ (i=1, 2, . . . , 8) of the refrigeration cycle control and the actions aⱼ (i=1, 2, . . . , 12) of the airflow control. For example, the reinforcement learner 350 selects, as the action aₜ, the control values output in response to input of the state sₜ, in accordance with the refrigeration cycle control model 7a or the airflow control model 7b. In more detail, the reinforcement learner 350 inputs the state sₜ into the refrigeration cycle control model 7a and the airflow control model 7b that are being updated by the reinforcement learning, and selects, as the action aₜ, the control values output from the refrigeration cycle control model 7a and the airflow control model 7b in response to input of the state sₜ. At the start of the reinforcement learning, the reinforcement learner 350 selects the action aₜ, using the refrigeration cycle control model 7a, the airflow control model 7b, and initial data on the state sₜ, which are prepared in advance.

After selecting the action aₜ, the simulator 330 simulates a state sₜ₊₁ at the time t+1 resulting from selection of the action aₜ in the state sₜ at the time t, using the simulation models 5. In other words, the simulator 330 predicts, how the state of the refrigeration cycle and the state of the indoor space 3 will vary from the time t to the time t+1 during air conditioning by the air conditioner 10 in a situation in which the state sₜ is given, and thus simulates a thermal environment of the indoor space 3 at the time t+1.

First, the simulator 330 simulates a state of the refrigeration cycle, using the simulation model 5a for the refrigeration cycle (Step S23). Specifically, the simulator 330 calculates a temperature of the condenser, a temperature of the evaporator, a frequency of the compressor 2c, an aperture of the expansion valve 2d, and a discharge superheat temperature, using the simulation model 5a, on the basis of the rotational speed of the indoor fan 1b, the rotational speed of the outdoor fan 2b, the frequency of the compressor 2c, the aperture of the expansion valve 2d, and the intake temperature of the indoor air introduced into the indoor unit 1. The simulator 330 also calculates a volume and temperature of the air delivered from the indoor fan 1b to the indoor space 3, using the simulation model 5a, on the basis of the rotational speed of the indoor fan 1b. The simulator 330 thus calculates a state sᵢ of the refrigeration cycle at the time t+1 resulting from selection of the action aᵢ of the refrigeration cycle control in the state sᵢ of the refrigeration cycle at the time t.

Second, the simulator 330 simulates a temperature distribution in the indoor space 3, using the simulation model 5b for the temperature distribution (Step S24). Specifically, the simulator 330 determines, as the boundary conditions of the outlet 1g, the temperature and volume of the delivered air calculated using the simulation model 5a for the refrigeration cycle, and thus simulates a temperature distribution and a wind speed distribution. The simulator 330 thus calculates a state sⱼ of the indoor space at the time t+1 resulting from selection of the action aⱼ of the airflow control in the state sⱼ of the indoor space at the time t.

After simulating the state of the refrigeration cycle and the temperature distribution, the reinforcement learner 350 calculates a reward value rt (Step S25). Specifically, the reinforcement learner 350 references the training data 6, and determines the temperatures Tₛₑₜ and humidities T_{set, RH} preferred by the user at the individual time points as target values. The reinforcement learner 350 then sets a reward value rₜ, which increases as the temperature and humidity of the indoor space 3 resulting from the refrigeration cycle control and the airflow control approach the respective target values of the temperature Tₛₑₜ and the humidity T_{set, RH}.

In more detail, the reinforcement learner 350 calculates a sensory temperature T′ (=T−4×√v), from the wind speed v and the temperature T at the position (x, y) of the user at the time t, which are indicated by the training data 6. The reinforcement learner 350 then calculates an evaluation score R represented by Expression (11), as a reward value rt. The evaluation score R is calculated by adding the difference between the sensory temperature T′ acquired through simulation of the thermal environment and the temperature Tₛₑₜ preferred by the user, to the difference between the humidity TRH acquired through simulation of the thermal environment and the humidity T_{set, RH} preferred by the user. λ₁ and λ₂ indicate weighting constants.

$$Expression 11$$

$$R = {λ}_{1} \vert {T}^{′} - {T}_{set} \vert + {λ}_{2} \vert {T}_{RH} - {T}_{set , RH} \vert \qquad ( 11 )$$

After calculating the reward value rₜ, the reinforcement learner 350 updates the state function Q(sₜ, aₜ) (Step S26). The reinforcement learner 350 accordingly updates the refrigeration cycle control model 7a and the airflow control model 7b. In an exemplary case of a trained model 7 made of a Q-table, the reinforcement learner 350 updates the Q-value in accordance with Expression (12).

$$Expression 12$$

$$Q ( {s}_{t} , {a}_{t} ) = {R}_{t + 1} + γ {max}_{a} Q ( {s}_{t + 1} , a ) \qquad ( 12 )$$

In contrast, in another exemplary case of a trained model 7 made of a neural network, the reinforcement learner 350 updates the weight coefficients of the neural network in accordance with Expression (13).

$$Expression 13$$

$$E ( {s}_{t} , {a}_{t} ) = ( {R}_{t} + γ {{max}_{a} ( Q ( {s}_{t + 1} , a ) - Q ( {s}_{t} , {a}_{t} ) )}^{2} \qquad ( 13 )$$

After updating the state function Q(sₜ, aₜ), the reinforcement learner 350 determines whether the subsequent piece of training data 6 exists (Step S27). Specifically, the reinforcement learner 350 determines whether any unprocessed piece of data at the subsequent time point exists in the chronological pattern of the temperatures and humidities preferred by the user, which is indicated by the piece of training data 6.

When any subsequent piece of training data 6 exists (Step S27; YES), the reinforcement learner 350 returns to Step S22. In Step S22, the reinforcement learner 350 selects an action aₜ₊₁ to be taken in a situation in which a state sₜ₊₁ acquired through the simulation is given, and executes Steps S23 to S27 in accordance with the selected action aₜ₊₁. The reinforcement learner 350 repeats Steps S22 to S27 until completion of processing of the pieces of training data 6 for all the time points. These repetition of Steps S21 to S27 allows the reinforcement learner 350 to generate the refrigeration cycle control model 7a and the airflow control model 7b, as the trained models 7.

After completion of processing of all the pieces of training data 6 (Step S27; NO), the reinforcement learner 350 terminates the reinforcement learning process illustrated in FIG. 23. The reinforcement learner 350 causes the refrigeration cycle control model 7a and the airflow control model 7b, which are generated in the above-described reinforcement learning process, to be stored into the storage 32 in the form of the trained models 7.

### Outputter 360

Referring back to FIG. 10, the outputter 360 outputs the trained models 7 generated by the reinforcement learner 350. Specifically, the outputter 360 communicates with the air conditioning control device 50 via the input-output I/F 33, and transmits the trained models 7 stored in the storage 32 to the air conditioning control device 50. The outputter 360 is an example of output means.

### Application Phase

The following describes a phase of application of the trained models 7 generated by the learning device 30.

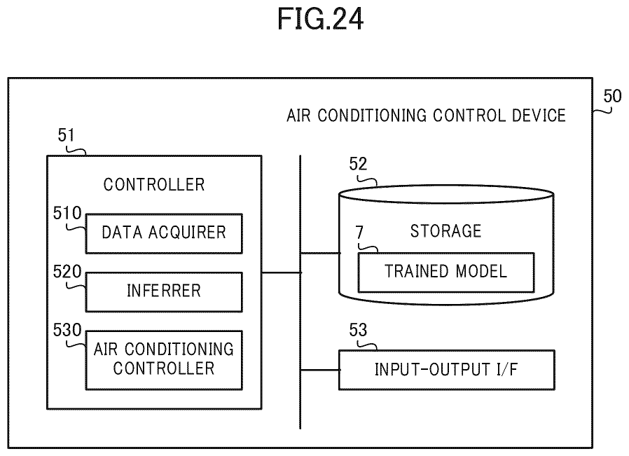

The air conditioning control device 50 illustrated in FIG. 1 controls the air conditioner 10, by means of the trained models 7 generated by the learning device 30. The air conditioning control device 50 is achieved by an information processing device, such as personal computer, server, or tablet. As illustrated in FIG. 24, the air conditioning control device 50 includes a controller 51, a storage 52, and an input-output I/F 53.

The controller 51 includes a CPU, a ROM, and a RAM. The CPU may also be called a central processing unit, central calculation unit, processor, microprocessor, or microcomputer, for example. The CPU serves as a central calculation processor that executes processes and calculations involved in the control operations of the air conditioning control device 50. The CPU in the controller 51 reads the programs and data stored in the ROM, and performs comprehensive control of the air conditioning control device 50, using the RAM as a work area.

The storage 52 includes a non-volatile semiconductor memory, such as flash memory, EPROM, or EEPROM, and serves as a so-called secondary storage or auxiliary storage. The storage 52 stores programs and data to be used in various processes executed by the controller 51. The storage 52 also stores data to be generated or acquired through various processes executed by the controller 51.

The storage 52 stores the trained models 7. The trained models 7 are generated by the learning device 30, acquired via the input-output I/F 53, and stored into the storage 32.

The input-output I/F 53 includes an interface that enables the air conditioning control device 50 to transmit and receive data to and from external modules. In a specific example, the input-output I/F 53 includes a communication module, such as LAN or USB, and a module for reading data from external storage devices.

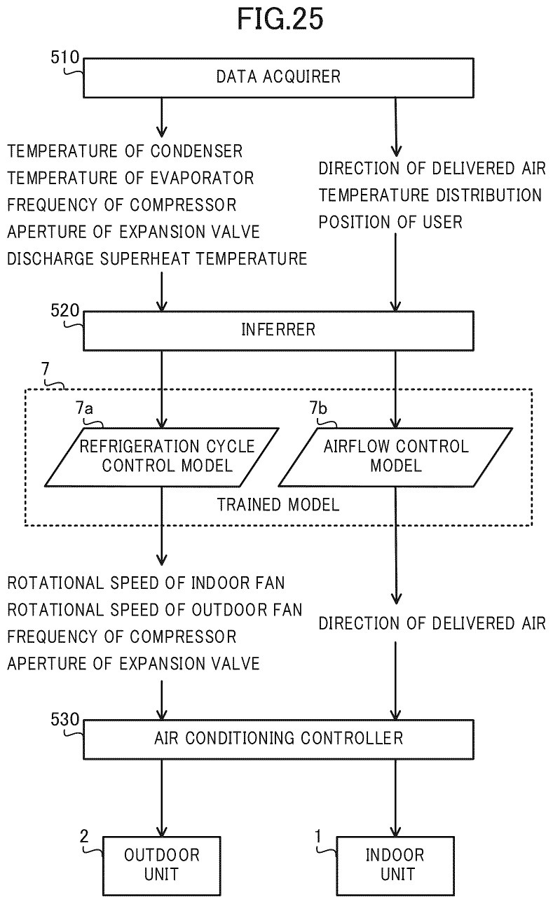

The controller 51 has functional components including a data acquirer 510, an inferrer 520, and an air conditioning controller 530. These functions are performed by software, firmware, or a combination of software and firmware. The software and firmware are described in the form of programs and stored in the ROM or the storage 52. The CPU reads and executes the programs stored in the ROM or the storage 52, and thus achieves the functions. The following describes the individual functions of the controller 51 with reference to FIG. 25.

Data acquirer 510 The data acquirer 510 acquires state data indicating a state of the refrigeration cycle and a state of the indoor space 3. The air conditioner 10 is provided with sensors at appropriate sites for measuring a state of the refrigeration cycle. The indoor space 3 is provided with sensors, such as temperature sensor, humidity sensor, and thermal image sensor, at appropriate sites for measuring a state of the indoor space 3. The data acquirer 510 communicates with these sensors via the input-output I/F 53 with predetermined time intervals, and thus acquires state data. The data acquirer 510 is an example of data acquisition means.

First, the data acquirer 510 acquires, as the state data indicating a state of the refrigeration cycle, pieces of data indicating the temperature of the indoor heat exchangers 1a, the temperature of the outdoor heat exchanger 2a, the frequency of the compressor 2c, the aperture of the expansion valve 2d, and the discharge superheat temperature. These pieces of data as the state data are measured by the sensors provided to some segments of the refrigeration cycle of the air conditioner 10 to measure a state of the refrigeration cycle. The data acquirer 510 acquires the state data indicating the state of the refrigeration cycle from these sensors.

Second, the data acquirer 510 acquires, as the state data indicating a state of the indoor space 3, pieces of data indicating the direction of the air delivered from the indoor unit 1 to the indoor space 3, the temperature distribution in the indoor space 3, and the position of a user in the indoor space 3. The direction of the delivered air is determined by the sensor provided to the outlet 1g of the indoor unit 1. The temperature distribution in the indoor space 3 is measured through detection of representative temperatures at multiple measurement sites in the indoor space 3 by the temperature sensors, or through detection of the temperature distribution on the surface of a wall or floor of the indoor space 3 by the thermal image sensor, for example. The position of a user in the indoor space 3 is determined through detection of a surface temperature of the human body by the thermal image sensor. The data acquirer 510 acquires the state data indicating a state of the indoor space 3 from these sensors.

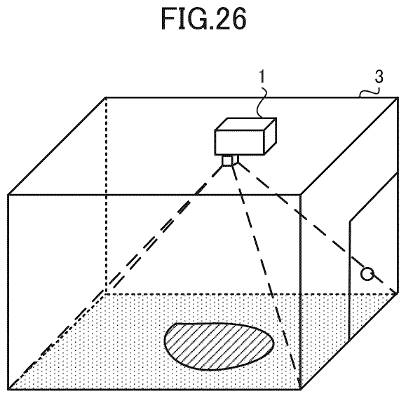

For example, as illustrated in FIG. 26, the temperature distribution in the indoor space 3 is measured by the thermal image sensor provided to the indoor unit 1. The hatched area in FIG. 26 represents the area warmed by receiving the warm air delivered from the indoor unit 1 in a downward direction. The data acquirer 510 measures such a temperature distribution, and thus acquires temperatures Tᵢ at 64 (=8×8) sites in the indoor space 3, for example.

### Inferrer 520

The inferrer 520 infers control values of the air conditioner 10 from the state data acquired by the data acquirer 510, using the trained models 7 generated by the learning device 30. Specifically, the inferrer 520 inputs the state data acquired by the data acquirer 510 into the trained models 7. The trained models 7, when receiving the input state data, output control values associated with the state data. The inferrer 520 provides the control values output from the trained models 7, as control values of the air conditioner 10. The inferrer 520 is an example of inference means.

In an exemplary case of a trained model 7 made of a Q-table, the inferrer 520 references the Q-table. The inferrer 520 then selects an action aₜ providing the highest Q-value among selectable actions aₜ, in the current state sₜ indicated by the state data acquired by the data acquirer 510, in accordance with Expression (14) below. The inferrer 520 determines the selected action aₜ to be the action aₜ₊₁ at the subsequent time point, which corresponds to control values of the air conditioner 10.

$$Expression 14$$

$${a}_{t + 1} = arg {max}_{j} Q ( {s}_{t , i} , {a}_{t , j} ) \qquad ( 14 )$$

In more detail, the trained models 7 include the refrigeration cycle control model 7a and the airflow control model 7b, as described above. The inferrer 520 infers control values of the air conditioner 10, using the refrigeration cycle control model 7a and the airflow control model 7b.

First, the inferrer 520 inputs the pieces of state data contained in the state data acquired by the data acquirer 510 and indicating the state sᵢ of the refrigeration cycle into the refrigeration cycle control model 7a. Specifically, the inferrer 520 inputs, as the state data indicating the state of the refrigeration cycle, the temperature of the indoor heat exchangers 1a, the temperature of the outdoor heat exchanger 2a, the frequency of the compressor 2c, the aperture of the expansion valve 2d, and the discharge superheat temperature, into the refrigeration cycle control model 7a.

The refrigeration cycle control model 7a, when receiving the input state sᵢ of the refrigeration cycle, outputs the optimum action aᵢ of the refrigeration cycle control associated with the state sᵢ. Specifically, the refrigeration cycle control model 7a outputs amounts of adjustment of the rotational speed of the indoor fan 1b, the rotational speed of the outdoor fan 2b, the frequency of the compressor 2c, and the aperture of the expansion valve 2d. The inferrer 520 infers these control values as the values for control of the refrigeration cycle to be achieved in the current state of the refrigeration cycle.

Second, the inferrer 520 inputs the pieces of state data contained in the state data acquired by the data acquirer 510 and indicating the state sⱼ of the indoor space 3 into the airflow control model 7b. Specifically, the inferrer 520 inputs, as the state data indicating the state of the indoor space 3, the direction of the air delivered from the indoor unit 1 to the indoor space 3, the temperature distribution in the indoor space 3, and the position of a user in the indoor space 3, into the airflow control model 7b.

The airflow control model 7b, when receiving the input state sⱼ of the indoor space 3, outputs the optimum action aⱼ of the airflow control associated with the state sⱼ. Specifically, the airflow control model 7b outputs amounts of adjustment of the volume, direction, and temperature of the delivered air, as the control values associated with the input state sⱼ. The inferrer 520 infers these control values as the values for control of the airflow to be achieved in the current state of the indoor space 3.

### Air Conditioning Controller 530

The air conditioning controller 530 controls the air conditioner 10, in accordance with the control values inferred by the inferrer 520. Specifically, the air conditioning controller 530 varies the rotational speed of the indoor fan 1b in the air conditioner 10, the rotational speed of the outdoor fan 2b, the frequency of the compressor 2c, the aperture of the expansion valve 2d, and the volume, direction, and temperature of the air delivered from the indoor unit 1, in accordance with the control values output from the trained models 7.

The air conditioning controller 530 communicates with the air conditioner 10 via the input-output I/F 53, and transmits the control values inferred by the inferrer 520 to the air conditioner 10. The air conditioning controller 530 thus causes the air conditioner 10 to operate in accordance with the inferred control values. The air conditioning controller 530 is an example of air conditioning control means.

The air conditioning control device 50 repeatedly executes the process of acquiring the state data by the data acquirer 510, the process of inferring control values using the trained models 7 by the inferrer 520, and the process of controlling the air conditioner by the air conditioning controller 530 described above, after every predetermined period. The air conditioning control device 50 thus causes the air conditioner 10 to operate in accordance with the optimum control values inferred in the current process, which vary according to a time variation in the state of the refrigeration cycle and the state of the indoor space 3. The air conditioning control device 50 is therefore capable of high-accuracy refrigeration cycle control and airflow control, and maintenance of the thermally comfortable state of the indoor space 3.

As described above, the learning device 30 according to Embodiment 1 simulates a thermal environment of the indoor space 3 predicted to result from air conditioning of the indoor space 3 by the air conditioner 10, and executes reinforcement learning that employs, as a reward, a value based on the simulated thermal environment. The learning device 30 thus generates trained models 7 aimed at inferring control values of the air conditioner 10 from the thermal environment. The learning device 30 can execute reinforcement learning in a simulated environment, without acquiring values measured in the actual environment including the air conditioner 10. This configuration can reduce the period for the reinforcement learning, and ensure a large number of training processes in the reinforcement learning, leading to acceleration of the reinforcement learning.

### Embodiment 2

The following describes Embodiment 2, without redundant description of the components and functions identical to those in Embodiment 1.

The reinforcement learner 350 according to Embodiment 1 learns the optimum refrigeration cycle control and airflow control associated with the state of the indoor space 3, using the training data 6 prepared in advance. In contrast, a learning device 30 according to Embodiment 2 is capable of generating the training data 6.

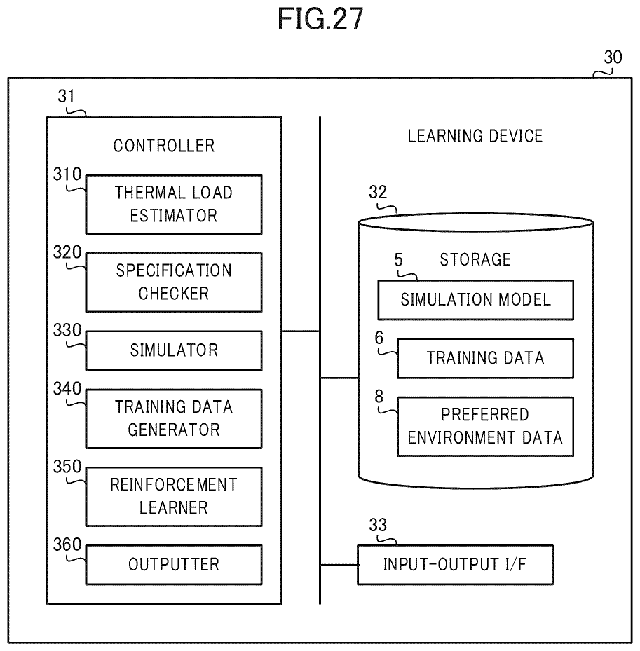

FIG. 27 illustrates the learning device 30 according to Embodiment 2. In the learning device 30 according to Embodiment 2, the controller 31 has functional components including a thermal load estimator 310, a specification checker 320, a simulator 330, a training data generator 340, a reinforcement learner 350, and an outputter 360. The functional components other than the training data generator 340 are identical to those in Embodiment 1 and not redundantly described.

The training data generator 340 references pieces of preferred environment data 8 stored in the storage 32 and thus generates the training data 6. The pieces of preferred environment data 8 are pieces of data, collected from the users, on the measured temperatures and humidities indicating the thermal environments preferred by multiple users. The training data generator 340 executes a process of collecting pieces of preferred environment data 8, and a process of generating the training data 6 on the basis of the collected pieces of preferred environment data 8. The training data generator 340 is an example of training data generation means.

Collection of pieces of preferred environment data 8 The training data generator 340 collects pieces of preferred environment data 8 on the basis of measured values in lives of approximately 100 users. Specifically, the training data generator 340 measures pieces of chronological data on the measured physical properties of the individual users while the users stay in the indoor space 3, using wearable terminals, such as smartwatches, held by the users. Examples of the measured physical properties include body temperature, amount of movements, and heart rate.

In addition, the training data generator 340 captures images of users with a camera provided to the indoor space 3, and acquires information on the amounts of movements of the users, the positional relationships between the users and the air conditioner 10, and the clothing of the users. The training data generator 340 then infers metabolic energies of the users from the amounts of movements of the users, infers wind speeds of the air delivered directly to the users from the positional relationships between the users and the air conditioner 10, and infers amounts of clothing of the users from the clothing of the users. The training data generator 340 also causes the temperature and humidity of the indoor space 3 measured by a thermo-hygrometer to be stored in association with the pieces of chronological data on the measured physical properties.

The training data generator 340 executes the steps (1) to (3) below, for each piece of chronological data on each user. (1) The training data generator 340 calculates a predicted mean vote (PMV), which is an index indicating a thermal comfort level of each user, from the amount of movements of the user and the temperature and humidity of the indoor space 3. The calculation of a PMV value requires a metabolic energy, an amount of clothing, an air temperature, a mean radiant temperature, a mean wind speed, and a relative humidity. These pieces of information are acquired with the wearable terminal held by the user, the camera for capturing an image of the user, and the thermo-hygrometer.

(2) The training data generator 340 quantifies the stress level of the user, from the heart rate of the user. The training data generator 340 also defines a threshold of the stress level. The training data generator 340 determines that the user exists in a thermally uncomfortable environment when the stress level exceeds the threshold.

(3) When determining that the user exists in a thermally uncomfortable environment, the training data generator 340 calculates a PMV value of the user, and then calculates differences from the measured temperature and measured humidity that can achieve the PMV value of the user equal to 0, that is, achieve a thermally neutral state of the user. For example, when the PMV value is lower than 0, the training data generator 340 corrects the temperature preferred by the user into a value higher than the measured temperature. The training data generator 340 thus determines the temperature and humidity that achieve the PMV value equal to 0, to be the temperature and humidity preferred by the user.

That is, the training data generator 340 infers the temperature and humidity preferred by the user, on the basis of the PMV value of the user. The training data generator 340 infers temperatures and humidities preferred by the user at multiple time points, and generates a piece of data indicating a chronological pattern of the inferred temperatures and humidities, in the form of the piece of preferred environment data 8 on this user.

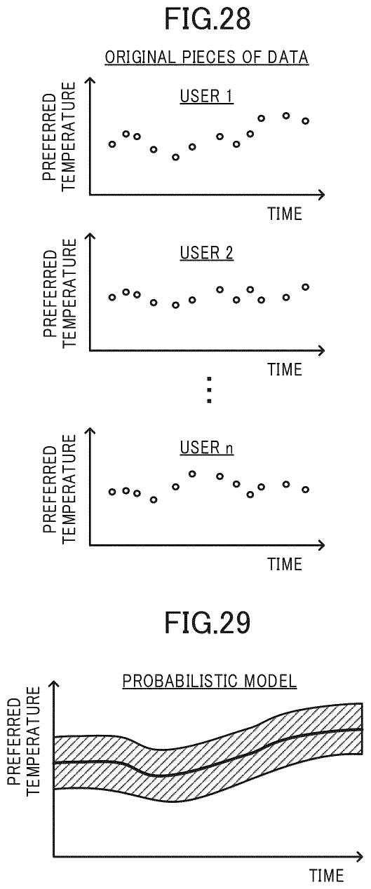

The training data generator 340 generates such a piece of preferred environment data 8 for each of the approximately 100 users. The training data generator 340 thus yields pieces of preferred environment data 8 each indicating a chronological pattern of temperatures and humidities preferred by each of the users, for example, as illustrated in FIG. 28. The training data generator 340 causes the generated pieces of preferred environment data 8 to be stored into the storage 32.

### Generation of Training Data 6

After collecting the pieces of preferred environment data 8, the training data generator 340 generates the training data 6 on the basis of the pieces of preferred environment data 8. As the number of pieces of training data 6 increases, the accuracy of the learning is improved. Such many pieces of training data 6, however, must be collected from a large number of users having various attributes, such as age, sex, and physical size. The pieces of training data 6 can be collected from users in the form of a questionnaire, for example, but such a collecting procedure requires a huge amount of cost and time. In order to solve this problem, the training data generator 340 in Embodiment 2 generates the training data 6 from a small number of pieces of original measured data, using the pieces of preferred environment data 8.

The training data generator 340 generates a probabilistic model on the basis of the collected pieces of preferred environment data 8. Specifically, the training data generator 340 classifies the pieces of preferred environment data 8 on multiple users, into groups associated with users having similar attributes, such as age, sex, and physical size, and the number of users in the indoor space 3, for example. The training data generator 340 applies the Gaussian process to the classified pieces of data, and thus generates a probabilistic model.

The following describes a method of generating a probabilistic model representing a relationship between the time t and the preferred temperature (output: y), using the Gaussian process. yᵢ(t) indicates a piece of preferred environment data 8 on the user i, who is the i-th user among multiple users. The piece of data yᵢ contains a temperature Tᵢ preferred by the user i, a humidity T_{RH, i} preferred by the user i, and position coordinates (x coordinate: xᵢ, y coordinate: yᵢ) of the user i relative to the position of the air conditioner 10. The training data generator 340 combines the time tᵢ and the piece of data yᵢ (=(Tᵢ, T_{RH}, i, xᵢ, yᵢ)), and thus generates a data set Yᵢ=(tᵢ, yᵢ) on the user i.

FIG. 29 illustrates a probabilistic model based on the Gaussian process generated from the pieces of preferred environment data 8 on multiple users illustrated in FIG. 28. The probabilistic model illustrated in FIG. 29 represents a probabilistic range of the preferred temperature T of the users at the time t. The Gaussian process is a method of regression of the value x into the output y, using a weight coefficient wᵢ of a stochastic process in accordance with a normal distribution, and a non-linear function φᵢ(t) with respect to the time t, as is represented by Expression (15).

$$Expression 15$$

$$y = {\sum }_{i} {w}_{i} ϕ ( {x}_{i} ) \qquad ( 15 )$$

When the kernel function k(xᵢ, xⱼ), which is defined by the equation “k(xᵢ, xⱼ)=φᵢ(x)φⱼ(x)”, is provided with a specific function form as is represented in Expression (16), the output y can be expressed in a multidimensional normal distribution of the mean (x) and the variance V(x) as is represented by Expression (18), containing the gram matrix K represented by Expression (17).

$$Expression 16$$

$$k ( {x}_{i} , {x}_{j} ) = α exp ( \to \frac{{‖ {x}_{i} - {x}_{j} ‖}^{2}}{2 {l}^{3}} ) \qquad ( 16 )$$

$$Expression 17$$

$$K = ( \begin{matrix}k ( {x}_{1} , {x}_{1} ) & ⋯ & k ( {x}_{1} , {x}_{n} ) \\ ⋮ & ⋱ & ⋮ \\ k ( {x}_{n} , {x}_{1} ) & ⋯ & k ( {x}_{n} , {x}_{n} )\end{matrix} ) \qquad ( 17 )$$

The mean (x) and the variance V(x) are represented by Expressions (19) and (20), containing two vectors y_{ob}=(y₁, y₂, . . . , y₆)^{T} and k(x)=(k(x, x₁), k(x, x₂), . . . , k(x, x₆))^{T} and a matrix K_{ob} having an i-th row and j-th column component of (K_{ob})ᵢⱼ=(k(k(xᵢ, xₗ))). In FIG. 29, the thick line represents the mean (x), and the hatched area represents the range of the variance V(x).

$$Expression 18$$

$$y = \frac{1}{{( 2 π )}^{d / 2} √ det ( V ( x ) )} exp ( - \frac{1}{2} {( x - μ ( x ) )}^{T} {V ( x )}^{- 1} ( x - μ ( x ) ) ) \qquad ( 18 )$$

$$Expression 19$$

$$μ ( x ) = k ( x ) {K}_{ob}^{- 1} {y}_{ob} \qquad ( 19 )$$

$$Expression 20$$

$$V ( x ) = k ( x , x ) - {k ( x )}^{T} k ( x ) \qquad ( 20 )$$

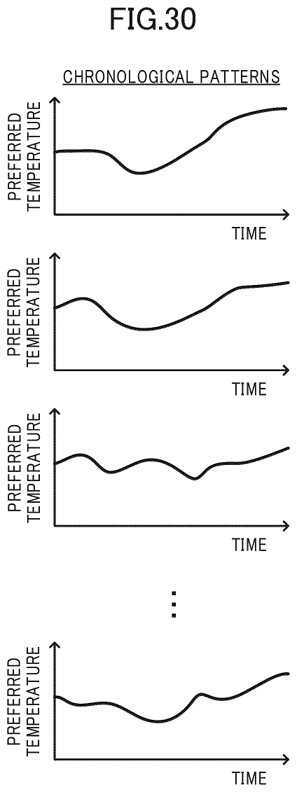

On the basis of the probabilistic model based on the Gaussian process generated as described above, the training data generator 340 outputs chronological patterns by a sampling method, such as Markov chain Monte Carlo (MCMC) method. Specifically, as illustrated in FIG. 30, the training data generator 340 generates multiple chronological patterns from the single probabilistic model illustrated in FIG. 29. The training data generator 340 generates, as the training data 6, pieces of data indicating multiple chronological patterns generated from a single probabilistic model, and causes the generated training data 6 to be stored into the storage 32.

Since multiple chronological patterns are generated from a single probabilistic model, the training data 6 containing a large number of chronological patterns can be generated from measured pieces of data on the thermal environments preferred by a small number of users. The resulting many pieces of data as the training data 6 can be applied to the reinforcement learning, thereby improving the accuracy of the learning.

The training data generator 340 in Embodiment 2 may update the training data 6 that has already been generated. For example, the training data generator 340 determines whether the training data 6 needs to be updated, after execution of the reinforcement learning process illustrated in FIG. 23 in Embodiment 1. Specifically, the training data generator 340 determines whether the calculated reward value satisfies a predetermined standard of convergence test. When determining that the reward value fails to satisfy the standard, the training data generator 340 determines that the training data 6 need to be updated.

When determining that the training data 6 needs to be updated, the training data generator 340 updates the training data 6. Specifically, the training data generator 340 regenerates a probabilistic model based on the Gaussian process from the pieces of preferred environment data 8, and generates new training data 6. The learning device 30 then executes reinforcement learning by repeating Steps S22 to S27 illustrated in FIG. 23, using the updated training data 6, and generates new trained models 7. The training data generator 340 may continue such updating processes for training data until the calculated reward value satisfies the standard of convergence test.

### Embodiment 3

The following describes Embodiment 3, without redundant description of the components and functions identical to those in Embodiments 1 and 2.

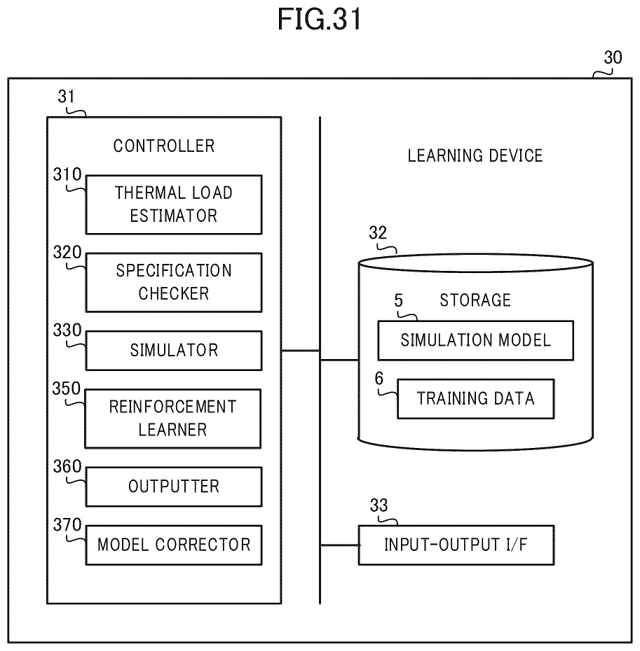

FIG. 31 illustrates a configuration of a learning device 30 according to Embodiment 3. In the learning device 30 according to Embodiment 3, the controller 31 has functional components including a thermal load estimator 310, a specification checker 320, a simulator 330, a reinforcement learner 350, an outputter 360, and a model corrector 370. The functions other than the model corrector 370 are identical to those in Embodiment 1 and not redundantly described.

The model corrector 370 corrects the trained models 7, in accordance with the control values inferred based on the trained models 7 generated by the reinforcement learner 350, on the basis of an operation on the air conditioner 10 received from the user during the air conditioning of the indoor space 3 by the air conditioner 10. The model corrector 370 is an example of model correction means.

The trained models 7 generated by the reinforcement learner 350 of the learning device 30 are output from the outputter 360 to the air conditioning control device 50, as in Embodiment 1. The air conditioning control device 50 then causes the air conditioner 10 to condition the air in the indoor space 3, in accordance with the control values inferred based on the trained models 7 acquired from the learning device 30.

When a user existing in the indoor space 3 inputs any operation into the air conditioner 10 during the air conditioning of the indoor space 3 by the air conditioner 10 being controlled based on the trained models 7, the model corrector 370 determines whether the control values inferred based on the trained models 7 are appropriate, in accordance with the user's operation. The model corrector 370 then corrects the trained models 7 so as to enable the trained models 7 to infer the control values of the air conditioner 10 with higher accuracy, in accordance with the user's operation. That is, the model corrector 370 corrects the trained models 7 that have already been generated by the learning device 30, in accordance with a user's operation provided during the actual control of the air conditioner.

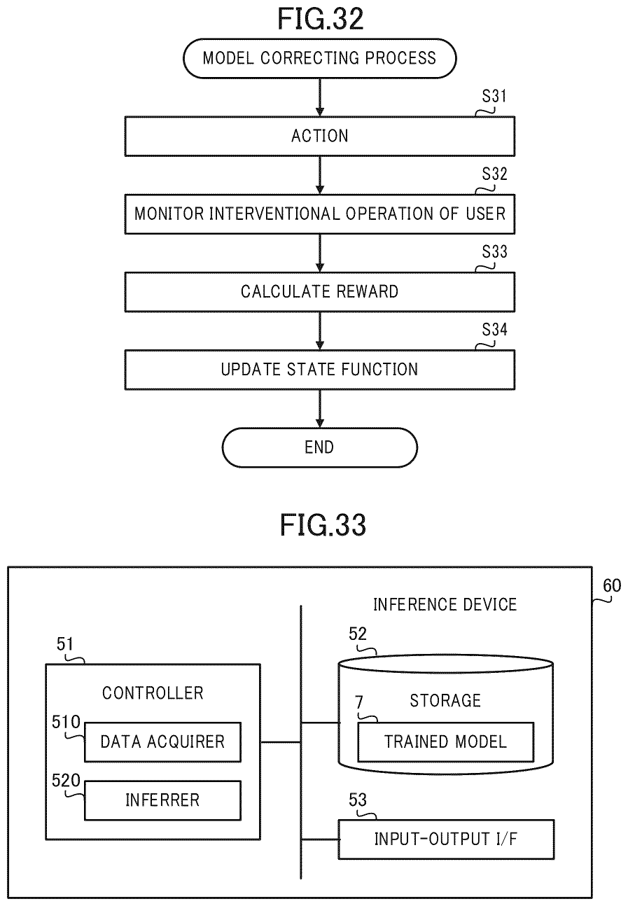

The following describes a model correcting process executed by the learning device 30 according to Embodiment 3, with reference to FIG. 32. The model correcting process illustrated in FIG. 32 is executed as required, during the air conditioning of the indoor space 3 by the air conditioner 10 being controlled based on the trained models 7.

At the start of the model correcting process, the model corrector 370 acquires information indicating the action aₜ in the air conditioner 10 (Step S31). Specifically, the model corrector 370 communicates with the air conditioning control device 50 via the input-output I/F 33, and thus acquires the information indicating the control values transmitted from the air conditioning control device 50 to the air conditioner 10.

After acquiring the information indicating the action aₜ, the model corrector 370 monitors whether any interventional operation is input from a user (Step S32). For example, the user can manipulate a manipulation unit, such as remote control, of the air conditioner 10 during the operation of the air conditioner 10, and thus input an operation of changing the set temperature, an operation of changing the set airflow direction, or an operation of deactivating the air conditioner 10, for example. The model corrector 370 communicates with the air conditioner 10 via the input-output I/F 33, and thus determines whether the air conditioner 10 has received such an operation from a user.

The model corrector 370 then calculates a reward to be given in the reinforcement learning for correcting the trained models 7, depending on whether any interventional operation is provided from the user (Step S33). Specifically, the model corrector 370 calculates a positive or negative reward in accordance with the rules (a) to (d) below.
(a) When receiving no operation from the user within a certain period, the model corrector 370 determines the latest control procedures to be appropriate and gives a positive reward.
(b) When receiving any operation from the user within the certain period, which is intended to change the set temperature, the model corrector 370 determines the refrigeration cycle control to be inappropriate and gives a negative reward.
(c) When receiving any operation from the user within the certain period, which is intended to change the set airflow direction, the model corrector 370 determines the airflow control to be inappropriate and gives a negative reward.
(d) When receiving any operation from the user within the certain period, which is intended to deactivate the air conditioner 10, the model corrector 370 determines the control procedure for the air conditioner 10 to be inappropriate, and gives a negative reward inferior to that in the case of a change in the set temperature or set airflow direction.

After calculating a reward, the model corrector 370 updates the state function on the basis of the calculated reward (Step S34). Specifically, the model corrector 370 updates the Q-values in accordance with Expression (12), or updates the weight coefficients of the neural networks in accordance with Expression (13), as in Embodiment 1. The model corrector 370 thus corrects the trained models 7.

Specifically, when receiving an operation intended to change the set temperature from the user, the model corrector 370 corrects the refrigeration cycle control model 7a. Alternatively, when receiving an operation intended to change the set airflow direction from the user, the model corrector 370 corrects the airflow control model 7b. In contrast, when receiving no operation from the user or receiving an operation for deactivation from the user, the model corrector 370 corrects both of the refrigeration cycle control model 7a and the airflow control model 7b. The model corrector 370 then terminates the model correcting process illustrated in FIG. 32.

As described above, the learning device 30 according to Embodiment 3 corrects the trained models 7, on the basis of an operation received from the user during air conditioning of the indoor space 3 by the air conditioner 10. The learning device 30 corrects the trained models 7 in view of variations in the environment caused by the operation in the real environment, and can therefore further improve the accuracy of the trained models 7.

### Embodiment 4

The following describes Embodiment 4, without redundant description of the components and functions identical to those in Embodiments 1 to 3.

The learning device 30 according to the above-described embodiments simulates a thermal environment of the indoor space 3, and generates trained models 7 by the reinforcement learning on the basis of results of the simulation. The trained models 7 are transmitted to and used in the air conditioning control device 50 that controls the air conditioner 10 installed in the indoor space 3. In contrast, the trained models 7 in Embodiment 4 are transmitted to and used in a device that controls an air conditioner other than the air conditioner 10, which conditions the air in a space other than the indoor space 3.

For example, the trained models 7 used in an air conditioner owned by an existing user are applied to another air conditioner introduced by a new user. In this case, the trained models 7 may be updated suitably for the environment of the other air conditioner of the new user by means of transfer learning. The trained models 7 generated in a certain environment can thus be applied to another environment, and made applicable to various environments.

### Embodiment 5

The following describes Embodiment 5, without redundant description of the components and functions identical to those in Embodiments 1 to 4.

The learning device 30 according to the above-described embodiments simulates a temperature distribution in the indoor space 3, which is the thermal environment of the indoor space 3, and generates the airflow control model 7b aimed at controlling airflow in the indoor space 3, as the trained models 7. In contrast, the learning device 30 according to Embodiment 5 simulates a level of air quality of the indoor space 3, which is the thermal environment of the indoor space 3, and generates a trained model 7 aimed at inferring timings of ventilating the indoor space 3 from the state of the indoor space 3.

Examples of the air quality include a CO₂ concentration indicating a concentration of carbon dioxide in the air, a particulate matter (PM) concentration indicating a concentration of particulate matters in the air, and a formaldehyde concentration in the air. The CO₂ and PM concentrations in the indoor space 3 can be improved by ventilation through opening of the window, activation of a ventilation fan, for example. The formaldehyde concentration in the indoor space 3 can be improved by ventilation or activation of an air purifier. The ventilation or activation of an air purifier is performed by a user in response to a notification of a timing of ventilation transmitted from the air conditioner 10 to the user. A typical example of the notification of a timing of ventilation from the air conditioner 10 is an alert warning for recommending ventilation displayed on a display of a remote control, a display of the body of the air conditioner 10, or a smartphone owned by the user.

The user, however, will be annoyed if the user is frequently recommended to perform ventilation or air purification. Such frequent ventilation fluctuates the temperature of the indoor space 3, and thus impairs the comfort level of the thermal environment in the indoor space 3. In order to solve these problems, the learning device 30 according to Embodiment 5 simulates a level of air quality of the indoor space 3, using a simulation model 5 for the air quality. The learning device 30 then executes reinforcement learning that employs, as a reward, a value based on the simulated level of air quality, and learns the optimum timings of ventilation.

Learning of timings of ventilation using the simulation model for the air quality The simulator 330 simulates a level of air quality that is the thermal environment of the indoor space 3 predicted to result from air conditioning of the indoor space 3 by the air conditioner 10 in a situation in which a state of the indoor space 3 is given. The state of the indoor space 3 in Embodiment 5 is a condition of whether a user ventilates the indoor space 3.

The simulator 330 simulates a level of air quality in the indoor space 3 using the simulation model for the air quality. The simulation model for the air quality can be generated using ordinary differential equations. The following describes an exemplary simulation model for the air quality for predicting a CO₂ concentration in the indoor space 3. The simulation model can be calculated in the same manner for materials in the air, other than CO₂, such as particulate matters and formaldehyde.

Specifically, the simulation model for the air quality is represented by Expression (21) below. In Expression (21), Vᵣₒₒₘ [m³] indicates a volumetric capacity of the indoor space 3, Cᵣₒₒₘ(t) [m³/m³] indicates a CO₂ concentration in the indoor space 3, Cᵢₙ [m³/m³] indicates a CO₂ concentration of the air entering the indoor space 3 from the outside, Cₒᵤₜ [m³/m³] indicates a CO₂ concentration of the air exiting the indoor space 3 to the outside, F [m³/h] indicates a flow rate of the air exchanged between the indoor space 3 and the outside, and fᵢₙ [m³/h] indicates a production rate of CO₂ in the indoor space 3.

$$Expression 21$$

$${V}_{room} ( \frac{{dC}_{room}}{dt} ) = ( {C}_{in} - {C}_{out} ) \cdot F + {f}_{in} \qquad ( 21 )$$

The CO₂ concentration in the outside is regarded to be equal to a concentration assumed on the basis of the environment of a region including the air conditioner 10. For example, the CO₂ concentration Cᵢₙ is set to 600 [ppm]. The CO₂ concentration Cₒᵤₜ is regarded to be equal to Cᵣₒₒₘ(t).

The flow rate F changes at a timing of ventilation of the indoor space 3. For example, the flow rate F is set to 5 [m³/h] for the closed indoor space 3, and to 15 [m³/h] for the opened indoor space 3. The indoor space 3 is assumed to be subject to production of CO₂ due to respiration of users. For example, the rate of production of CO₂ from a single user is regarded to be 0.02 [m³/h], and the total production rate fᵢₙ [m³/h] of CO₂ from a number of users is calculated by multiplying 0.02 by the number of users.

The simulator 330 switches the value of the flow rate F in Expression (21) at timings of ventilation of the indoor space 3. The simulator 330 then calculates a CO₂ concentration Cᵣₒₒₘ(t) at the time t in accordance with Expression (21). The ventilation of the indoor space 3 is performed by the user in response to a notification from the air conditioner 10 to the user.

The reinforcement learner 350 executes reinforcement learning that employs, as a reward, a value based on the level of air quality, which is the thermal environment simulated by the simulator 330, and generates a trained model 7. The generated trained model 7 is a model aimed at inferring the optimum timings of ventilation of the indoor space 3, which are control values of the air conditioner 10, from the state of the indoor space 3.

Specifically, the reinforcement learner 350 sets reward values, which include a positive reward for the level of air quality in the indoor space 3, and a negative reward for the number of ventilating operations performed within a certain period. The reinforcement learner 350 determines a higher level of air quality for a lower CO₂ concentration in the indoor space 3.

The reinforcement learner 350 executes reinforcement learning based on a condition of whether a user ventilates the indoor space 3. In other words, the reinforcement learning in Embodiment 5 has possible actions: an action of ventilating the indoor space 3, and an action of not ventilating the indoor space 3. In the case of ventilation of the indoor space 3, the simulator 330 applies the flow rate F of 15 [m³/h] to Expression (21), and calculates a CO₂ concentration Cᵣₒₒₘ(t) at the time t. In contrast, in the case of no ventilation of the indoor space 3, the simulator 330 applies the flow rate F of 5 [m³/h] to Expression (21), and calculates a CO₂ concentration Cᵣₒₒₘ(t) at the time t. The reinforcement learner 350 gives a negative reward, in accordance with how many times or how long the calculated CO₂ concentration Cᵣₒₒₘ(t) exceeds the range of recommended values in an indoor environment for 24 hours, for example.

The reinforcement learner 350 executes such reinforcement learning using the simulation model for the air quality, and learns the optimum timings of ventilation of the indoor space 3. The reinforcement learner 350 thus generates a trained model 7 aimed at inferring the optimum timings of ventilation from the state of the indoor space 3.

The reinforcement learner 350 may also learn timings of ventilation suitable for an environment of the user. For example, the user while sleeping for a part of the 24 hours cannot perform ventilation in response to the notification. The reinforcement learner 350 may cause the simulation to reflect such a time of day in which the user is unavailable, and repeat the reinforcement learning while preventing a timing of ventilation from being included in the unavailable time of day.

The inferrer 520 of the air conditioning control device 50 infers the optimum timings of ventilation using the trained model 7 generated by the learning device 30, and the air conditioning controller 530 recommends the user to ventilate the indoor space 3 at the inferred timings. The trained model 7 can be applied to the actual apparatus, and made applicable to various environments.

As described above, the learning device 30 according to Embodiment 5 simulates a level of air quality of the indoor space 3, and learns the optimum timings of ventilation of the indoor space 3 on the basis of results of the simulation. The learning device 30 can thus ensure a sufficiently high level of air quality while maintaining the comfort level of the thermal environment as high as possible.

### Embodiment 6

The following describes Embodiment 6, without redundant description of the components and functions identical to those in Embodiments 1 to 5.

The simulator 330 in Embodiment 5 simulates a level of air quality of the indoor space 3, which is the thermal environment of the indoor space 3. In contrast, the simulator 330 in Embodiment 6 simulates a variation in the temperature distribution in the indoor space 3 caused by ventilation, which is the thermal environment of the indoor space 3.

Learning of timings of ventilation using the simulation model for the temperature distribution The simulator 330 simulates a variation in the temperature distribution that is the thermal environment of the indoor space 3 predicted to result from air conditioning of the indoor space 3 by the air conditioner 10 in a situation in which the state of the indoor space 3 is given. The state of the indoor space 3 in Embodiment 6 is the condition of whether a user ventilates the indoor space 3, as in Embodiment 5.

The simulator 330 simulates a variation in the temperature distribution in the indoor space 3, using a simulation model for the temperature distribution. Specifically, the simulator 330 sets a volume of the exchanged air corresponding to ventilation, as a boundary condition, in the above-described simulation model 5b for the temperature distribution based on the MAC method. The simulator 330 can thus simulate a variation in the temperature distribution caused by ventilation.

In more detail, the simulator 330 sets a temperature Tᵢₙ[° C.] of the air entering the indoor space 3 from the outside, and a flow rate F [m³/h] of the air exchanged between the indoor space 3 and the outside due to ventilation. The simulator 330 also sets a boundary condition of the entering air corresponding to the aperture of the window for introducing the air, and a boundary condition of the exiting air corresponding to the aperture of the window for discharging the air, in the simulation model 5b for the temperature distribution. Under these setting conditions, the simulator 330 simulates a variation in the temperature distribution in the indoor space 3 caused by ventilation, using the simulation model 5b for the temperature distribution based on the MAC method.

The reinforcement learner 350 executes reinforcement learning that employs, as a reward, a value based on the thermal environment simulated by the simulator 330, and generates a trained model 7. Specifically, the reinforcement learner 350 determines the temperatures Tₛₑₜ preferred by the user at the individual time points as target values, and sets a reward value rₜ, which increases as the resulting temperatures approach the target values.

The reinforcement learner 350 executes reinforcement learning based on a condition of whether a user ventilates the indoor space 3, as in Embodiment 5. The reinforcement learner 350 accordingly generates a trained model 7 aimed at inferring the optimum timings of ventilation from the state of the indoor space 3. The trained model 7 is applicable to various environments, as in Embodiment 5.

As described above, the learning device 30 according to Embodiment 6 simulates a variation in the temperature distribution in the indoor space 3 caused by ventilation, and learns the optimum timings of ventilation of the indoor space 3. This learning can achieve ventilation while maintaining the comfort level of the thermal environment as high as possible.

### Modification

The above-described embodiments may be combined with each other, and some of the components in the embodiments may be modified or omitted as appropriate.

For example, the simulator 330 in the above-described embodiments simulates a thermal environment of the indoor space 3, using the simulation model 5a for the refrigeration cycle and the simulation model 5b for the temperature distribution as the simulation models 5. The reinforcement learner 350 generates the refrigeration cycle control model 7a and the airflow control model 7b as the trained models 7, on the basis of the simulation models 5. Alternatively, the simulator 330 may simulate a thermal environment of the indoor space 3, using either one of the simulation model 5a for the refrigeration cycle and the simulation model 5b for the temperature distribution alone. The reinforcement learner 350 may also generate either one of the refrigeration cycle control model 7a and the airflow control model 7b alone, as the trained models 7.

The simulation model 5a for the refrigeration cycle in the above-described embodiment serves to calculate an operation capacity of the indoor unit 1 and a volume and temperature of the air delivered from the indoor unit 1 to the indoor space 3, on the basis of the rotational speed of the indoor fan 1b, the rotational speed of the outdoor fan 2b, the frequency of the compressor 2c, the aperture of the expansion valve 2d, and the intake temperature of the air introduced into the indoor unit 1. The simulation model 5b for the temperature distribution serves to calculate a temperature distribution in the indoor space 3, on the basis of the dimensions and heat insulation performance of the indoor space 3, and the volume and direction of the air delivered from the indoor unit 1 to the indoor space 3. Alternatively, the simulation models 5a and 5b are not required to receive or output all of these parameters, and may receive or output only at least one of these parameters, or may receive or output a parameter other than these parameters.

The refrigeration cycle control model 7a in the above-described embodiments receives input of the temperature of the indoor heat exchangers 1a, the temperature of the outdoor heat exchanger 2a, the frequency of the compressor 2c, the aperture of the expansion valve 2d, and the discharge superheat temperature, and accordingly outputs values for control of the rotational speed of the indoor fan 1b, the rotational speed of the outdoor fan 2b, the frequency of the compressor 2c, and the aperture of the expansion valve 2d. The airflow control model 7b receives input of the direction of the delivered air, the temperature distribution in the indoor space 3, and the position of a user in the indoor space 3, and accordingly outputs values for control of the volume, direction, and temperature of the delivered air. Alternatively, the refrigeration cycle control model 7a is not required to receive or output all of these parameters, and may receive or output only at least one of these parameters, or receive or output a parameter other than these parameters.

The training data 6 in the above-described embodiments indicates chronological patterns of the temperatures and humidities preferred by users, as the target values of the reinforcement learning. Alternatively, the training data 6 may indicate temperatures alone or humidities alone as the target values, or may indicate parameters other than the temperatures and humidities.

The simulator 330 of the learning device 30 according to the above-described embodiments generates simulation models 5. Alternatively, the simulation models 5 may be generated by a device outside the learning device 30. The functions of the model corrector 370, which are described in Embodiment 3, may be performed by not the learning device 30 but the air conditioning control device 50.

The learning device 30 and the air conditioning control device 50, which are separate devices in the above-described embodiments, may also be the same device. The learning device 30 and the air conditioning control device 50 may be included inside the air conditioner 10 or reside in a cloud server. For example, the calculations of the neural networks in the inferrer 520 may be executed by a microcomputer in the indoor unit 1 or the outdoor unit 2. The neural networks may be implemented by a suitable microcomputer, in accordance with the calculation capacities of the memory and the microcomputer.

The inferrer 520 and the air conditioning controller 530, which are included in the air conditioning control device 50 in the above-described embodiments, may also be included in separate devices. For example, FIG. 33 illustrates an inference device 60 that includes a data acquirer 510 and an inferrer 520 but excludes an air conditioning controller 530. The inferrer 520 of the inference device 60 infers control values of the air conditioner 10 from the state data acquired by the data acquirer 510, using the trained models 7. The control values inferred by the inferrer 520 are then transmitted via an input-output I/F 53 to an external device including the air conditioning controller 530, and applied to the control of an air conditioner by the external device.

In the above-described embodiments, the controller 31 of the learning device 30 performs the functions of the thermal load estimator 310, the specification checker 320, the simulator 330, the training data generator 340, the reinforcement learner 350, the outputter 360, and the model corrector 370, when the CPU executes the programs stored in the ROM or the storage 32. Also, the controller 51 of the air conditioning control device 50 performs the functions of the data acquirer 510, the inferrer 520, and the air conditioning controller 530, when the CPU executes the programs stored in the ROM or the storage 52. Alternatively, the controllers 31 and 51 may be dedicated hardware. Examples of the dedicated hardware include single circuits, combined circuits, programmed processors, application specific integrated circuits (ASICs), field-programmable gate arrays (FPGAs), or combinations thereof. In the case where the controllers 31 and 51 are dedicated hardware, the individual functions of the components may be performed by separate pieces of hardware or may be collectively performed by a single piece of hardware.

A part of the functions of the components may be achieved by dedicated hardware, whereas the other part may be achieved by software or firmware. That is, the controllers 31 and 51 are able to perform the above-described functions by means of hardware, software, firmware, or a combination thereof.

Programs that define operations of the learning device 30 and the air conditioning control device 50 according to the present disclosure may be applied to an existing computer, such as personal computer or information terminal device, and may cause this computer to serve as the learning device 30 and the air conditioning control device 50 according to the present disclosure.

Such programs may be distributed by any procedure. For example, the programs may be stored in a non-transitory computer-readable recording medium, such as compact disk ROM (CD-ROM), digital versatile disk (DVD), magneto optical (MO) disk, or memory card, and distributed. The programs may also be distributed via a communication network, such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-000590, filed on Jan. 5, 2022, the entire disclosure of which is incorporated by reference herein.

Reference Signs List

| | |
|---|---|
| 1 | Indoor unit |
| 1a | Indoor heat exchanger |
| 1b | Indoor fan |
| 1c, 1d | Airflow direction controlling plate |
| 1e | Refrigerant piping |
| 1g | Outlet |
| 2 | Outdoor unit |
| 2a | Outdoor heat exchanger |
| 2b | Outdoor fan |
| 2c | Compressor |
| 2d | Expansion valve |
| 3 | Indoor space |
| 5, 5a, 5b | Simulation model |
| 6 | Training data |
| 7 | Trained model |
| 7a | Refrigeration cycle control model |
| 7b | Airflow control model |
| 8 | Preferred environment data |
| 10 | Air conditioner |
| 11 | Air conditioning system |
| 12 | Air conditioning control system |
| 30 | Learning device |
| 31 | Controller |
| 32 | Storage |
| 33 | Input-output I/F |
| 50 | Air conditioning control device |
| 51 | Controller |
| 52 | Storage |
| 53 | Input-output I/F |
| 60 | Inference device |
| 310 | Thermal load estimator |
| 320 | Specification checker |
| 330 | Simulator |
| 340 | Training data generator |
| 350 | Reinforcement learner |
| 360 | Outputter |
| 370 | Model corrector |
| 510 | Data acquirer |
| 520 | Inferrer |
| 530 | Air conditioning controller |

1. A learning device, comprising:
processing circuitry to
simulate a thermal environment of an indoor space, the thermal environment being predicted to result from air conditioning of the indoor space by an air conditioner in a situation in which at least one of a state of a refrigeration cycle included in the air conditioner or a state of the indoor space is given, and
execute reinforcement learning that employs, as a reward, a value based on the stimulated thermal environment, and thereby generate a trained model aimed at inferring, from the at least one of the state of the refrigeration cycle or the state of the indoor space, a control value of the air conditioner, wherein
the processing circuitry simulates, as the thermal environment, air quality of the indoor space, and
executes the reinforcement learning, and thereby generates the trained model aimed at inferring, from the state of the indoor space, a timing of ventilating the indoor space.

2. The learning device according to claim 1, wherein the processing circuitry simulates, using a simulation model for the refrigeration cycle generated based on specifications of the air conditioner, the thermal environment predicted to result from air conditioning of the indoor space by the air conditioner in a situation in which the state of the refrigeration cycle is given.

3. The learning device according to claim 2, wherein the simulation model for the refrigeration cycle is a model aimed at calculating, based on a control value of the refrigeration cycle, an operation capacity of the air conditioner, and a volume and a temperature of air delivered from the air conditioner to the indoor space.

4. The learning device according to claim 2, wherein
the processing circuitry generates, as the trained model, a refrigeration cycle control model for controlling the refrigeration cycle, and
the refrigeration cycle control model is a model aimed at inferring, from the state of the refrigeration cycle, a control value of the refrigeration cycle.

5. The learning device according to claim 4, wherein
the air conditioner includes an indoor heat exchanger, an indoor fan, an outdoor heat exchanger, an outdoor fan, a compressor, and an expansion valve,
the state of the refrigeration cycle is defined by at least one of a temperature of the indoor heat exchanger, a temperature of the outdoor heat exchanger, a frequency of the compressor, an aperture of the expansion valve, or a discharge superheat temperature, and
the control value of the refrigeration cycle is a value for control of at least one of a rotational speed of the indoor fan, a rotational speed of the outdoor fan, the frequency of the compressor, or the aperture of the expansion valve.

6. The learning device according to claim 1, wherein the processing circuitry simulates, using a simulation model for a temperature distribution in the indoor space, the thermal environment predicted to result from air conditioning of the indoor space by the air conditioner in a situation in which the state of the indoor space is given, the simulation model being generated based on specifications of the air conditioner, and dimensions and a heat insulation performance of the indoor space.

7. The learning device according to claim 6, wherein the simulation model for the temperature distribution is a model aimed at calculating the temperature distribution, based on the dimensions and the heat insulation performance of the indoor space and a volume and a direction of air delivered from the air conditioner to the indoor space.

8. The learning device according to claim 6, wherein
the processing circuitry means generates, as the trained model, an airflow control model for controlling airflow in the indoor space, and
the airflow control model is a model aimed at inferring, from the state of the indoor space, a control value of the airflow in the indoor space.

9. The learning device according to claim 8, wherein
the state of the indoor space is defined by at least one of a direction of air delivered from the air conditioner to the indoor space, the temperature distribution in the indoor space, or a position of a user in the indoor space, and
the control value of the airflow is a value for control of at least one of a volume, the direction, or a temperature of the delivered air.

10. The learning device according to claim 1 wherein
the processing circuitry
generates training data indicating a target value of the thermal environment, and
executes the reinforcement learning using the generated training data, and thereby generates the trained model.

11. The learning device according to claim 10, wherein the training data indicates, as the target value, a chronological pattern of temperatures preferred by a user.

12. The learning device according to claim 1,
wherein the processing circuitry corrects the trained model in response to an operation on the air conditioner, the operation being received from a user during air conditioning of the indoor space by the air conditioner in accordance with the control value inferred using the generated trained model.

13. (canceled)

14. The learning device according to claim 1, wherein
the processing circuitry
simulates, as the thermal environment, a variation in a temperature distribution in the indoor space caused by ventilation, and
executes the reinforcement learning, and thereby generates the trained model aimed at inferring, from the state of the indoor space, a timing of ventilating the indoor space.

15. An air conditioning control system, comprising:
the learning device according to claim 1; and
an air conditioning control device to control the air conditioner, wherein
the air conditioning control device includes processing circuitry to
acquire state data indicating the at least one of the state of the refrigeration cycle included in the air conditioner or the state of the indoor space,
infer the control value from the acquired state data, using the trained model generated by the learning device, and
control the air conditioner in accordance with the inferred control value.

16. An inference device, comprising:
processing circuitry to
acquire state data indicating a state of an indoor space, and
infer a timing of ventilating the indoor space from the acquired state data, using a trained model aimed at inferring the timing of ventilating the indoor space from the state of the indoor space, wherein
the trained model is a model generated by
simulating air quality of the indoor space, the air quality being predicted to result from air conditioning of the indoor space by an air conditioner in a situation in which the state of the indoor space is given, and
executing reinforcement learning that employs, as a reward, a value based on the simulated air quality.

17. An air conditioning control device, comprising:
the inference device according to claim 16, wherein
the processing circuitry controls the air conditioner in accordance with the inferred timing of ventilating the indoor space.

18. A method of generating a trained model, the method comprising:
simulating a thermal environment of an indoor space, the thermal environment being predicted to result from air conditioning of the indoor space by an air conditioner in a situation in which at least one of a state of a refrigeration cycle included in the air conditioner or a state of the indoor space is given; and
executing reinforcement learning that employs, as a reward, a value based on the simulated thermal environment, and thereby generating a trained model aimed at inferring, from the at least one of the state of the refrigeration cycle or the state of the indoor space, a control value of the air conditioner, wherein
simulating the thermal environment includes simulating, as the thermal environment, air quality of the indoor space, and
generating the trained model includes executing the reinforcement learning, and thereby generating the trained model aimed at inferring, from the state of the indoor space, a timing of ventilating the indoor space.

19. (canceled)

20. (canceled)
